(19) United States
(12) Patent Application Publication
(10) Pub. No.: US 2007/0019226 A1
(43) Pub. Date: Jan. 25, 2007

(54) Image forming apparatus and program, which are easy to use

(75) Inventors: Tsumoru Matsuura, Toyokawa-shi (JP); Hideki Hino, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/397,798

(22) Filed: Apr. 5, 2006

(30) Foreign Application Priority Data
Jul. 20, 2005 (JP) 2005-210417

(51) Int. Cl. G06K 15/00

(52) U.S. Cl. 358/1.14; 358/1.15

(57) ABSTRACT

An MFP, being an image forming apparatus, when confirming that a print job is the last one of a plurality of sequentially requested print jobs issued from a client terminal (Step S23), judges whether a notification management table stores any print job having the same EMAILTO name as an EMAILTO name that is a destination of notification regarding the last print job (Step S25). When the judgment of Step S25 results in the affirmative, e-mail including completion of these print jobs destined for the EMAILTO name is created and transmitted to the client terminal.

This application is based on application No. 2005-210417 filed in Japan, the content of which is hereby incorporated by reference.

### BACKGROUND OF THE INVENTION

(1) Field of the Invention

The present invention relates to an image forming apparatus and a program, for executing a print job based on a print instruction received from a client terminal, and transmitting notification of corresponding print job completion to the client terminal.

(2) Related Art

Recently, image forming apparatuses (e.g. a multiple function peripheral (MFP) and a printer) equipped with many functions and having fast processing speed are on sale. Such image forming apparatuses are comparatively expensive, and require a certain amount of space for installment.

Therefore, such an image forming apparatus is usually used as a network printer for a plurality of users, and not as a local printer exclusively for one user.

However, when an image forming apparatus is used as a network printer, there will be the following problem. Among the users of the network printer, some users must be seated far from the image forming apparatus, and so have difficulty in finding out whether their print job has ended. Therefore, cases arise where such users, coming to fetch the printout, find the print job incomplete even when a predetermined time has passed after they have issued a print instruction.

To counter this problem, for example, a Japanese Laid-open patent application H10-285329 proposes the following image forming apparatus. This image forming apparatus, upon completion of a print job in accordance with a print instruction received from a user (client terminal), transmits a completion notification for reporting the completion to the user (occasionally referred to as “notification” in the present invention) using e-mail for example.

However, with a conventional technology, when a number of print instructions are sequentially issued to an image forming apparatus, for example, the user will have to receive the same number of completion notifications, which is sometimes an annoyance to users. Besides, there will be many completion notifications to be received from the image forming apparatus, which increases loads to the network traffic.

### SUMMARY OF THE INVENTION

The present invention has been conceived in view of the above-stated problem, and has an object of providing an image forming apparatus, which, when there are a plurality of sequential print instructions, prevents users from feeling annoyed of notifications of print job completion, and prevent network traffic load from increasing which is attributable to the notifications.

So as to achieve the above object, an image forming apparatus of the present invention is an image forming apparatus that executes a print job according to a print instruction from a client terminal, and transmits a completion notification of the print job to the client terminal, the image forming apparatus having: a halting unit for, when the print job satisfies a predetermined condition, creating a halt state in which transmission of the completion notification is halted; and a collective notification unit for, if the halt state is cancelled with a plurality of completion notifications being halted, transmitting the plurality of completion notifications as at least one collective notification, a number of the at least one collective notification being smaller than a number of the plurality of completion notifications.

With the stated structure, it is possible to transmit a plurality of completion notifications whose transmission has been halted due to the halt state, as at least one collective notification, a number of the at least one collective notification being smaller than a number of the plurality of completion notifications.

For example when there are a plurality of print instructions (i.e. when another print instruction is received from the client terminal subsequent to the print instruction having been just received) one collective completion notification is used to report completion of corresponding print jobs, instead of transmitting the same number of completion notifications as the number of print instructions. This is a reduction in number of notification used for reporting print job completion. Therefore, the number of notification to be received by the user via the image forming apparatus is accordingly reduced. This means that the user is relieved of the annoyance of receiving the same number of job completion notifications as the number of the requested print jobs. Furthermore, the number of completion notifications to be transmitted on the network is lessened, which contributes to reduction of network traffic load.

Here, after “cancellation of the halt state”, the image forming apparatus moves to a state in which halted completion notification transmission becomes possible.

Here, “completion notification” is a concept including a notification (e.g. webmail) where a user can browse from any client terminal connected to the network, a notification (e.g. message) that is transmitted to a fixed client terminal of the user, mail that a fixed client terminal obtains by automatic access, and the like.

Also with the stated structure, it is also possible to transmit all the completion notifications whose transmission has been halted due to the halt state, as at least one collective notification, where the number of the at least collective notification being smaller than the number of the plurality of completion notifications.

In other words, the present invention is not limited to the case where only a plurality of completion notification are transmitted by only one collective notification, but also includes such a case as detailed as follows.

For example, suppose a case where four completion notifications have been halted due to the halt state. Then the halted completion notifications may be transmitted in any of the following manner: (a) as one collective notification; (b) as two collective notifications each for two completion notifications; and (c) as two collective notifications, one for one completion notification and the other for three completion notifications.

Here, the image forming apparatus may further have a halting judgment unit for judging whether the print job satisfies a predetermined condition, where the halting judgment unit judges in the affirmative if another print instruction is received from the client terminal subsequent to the print instruction regarding the print job.

Note that the timing of judgment performed by the halting judgment unit is not particularly limited as long as it is able to halt corresponding completion notification transmission. For example, the timing may be upon reception of a print instruction, in execution of a print job, and in (or before) creation of completion notification of a print job after the print job completion, and immediately before transmission of the completion notification.

Here, the halting judgment unit may perform the judgment by checking whether the print instruction regarding the print job is assigned sequential information indicating a presence of another print instruction to be received from the client terminal subsequent to the print instruction regarding the print job.

Note that “sequential information” may be of any content, form, and the like, as long as it indicates apresence of another print instruction to be received from the client terminal subsequent to a print instruction to which the sequential information is assigned. Furthermore, this sequential information may be integrated with (or contained in) a corresponding print instruction. Alternatively, the sequential information may be received independently (or in a separate body) from the print instruction.

Here, the image forming apparatus may further have: a cancellation judgment unit for judging whether the halt state should be cancelled, where the cancellation judgment unit judges in the affirmative if no print instruction is received subsequent to the print instruction regarding the print job.

In addition, the cancellation judgment unit may perform the judgment by checking whether the print instruction regarding the print job is assigned last-job information indicating no presence of another print instruction to be received from the client terminal subsequent to the print instruction regarding the print job.

Note that “last-job information” may be of any content, form, and the like, as long as it indicates no presence of another print instruction to be received from the client terminal subsequent to a print instruction to which the last-job information is assigned. Furthermore, this last-job information may be integrated with (or contained in) a corresponding print instruction. Alternatively, the last-job information may be received independently (or in a separate body) from the print instruction.

Here, the collective notification unit, when a print instruction assigned the last-job information has not been received for a predetermined time from a most recent print job completion, may transmit the collective notification.

With the stated structure, for example when there is no last job, or when the user has forgotten to set the last job, the user can still obtain the completion notification with respect to so-far completed print jobs. Note that “predetermined time” may be set by a manager of the image forming apparatus, or by a user of the image forming apparatus. Alternatively, the predetermined time may be pre-set in advance in the image forming apparatus.

Here, the image forming apparatus may further have: an accumulation unit for accumulating information relating to a print job whose print instruction has been received, where

the halting judgment unit judges in the affirmative when a new print instruction is received from the client terminal before transmission of a completion notification of an already completed print job issued from the client terminal.

With the stated structure, the image forming apparatus is able to properly determine the presence/non-presence of another print instruction to be received from the client terminal subsequent to a print instruction just having been received, without user's specification as to the presence/non-presence of such another print instruction.

In addition, the image forming apparatus may further have: a cancellation judgment unit for judging whether the halt state should be cancelled, where the halting judgment unit judges in the affirmative when the accumulation unit stores information relating to notification regarding any print job already completed, and the cancellation judgment unit judges in the affirmative when all print jobs whose information is stored in the accumulation unit are completed.

With the stated structure, the image forming apparatus is able to properly determine the presence/non-presence of another print instruction to be received from the client terminal subsequent to a print instruction just having been received, without user's specification as to the presence/non-presence of such another print instruction.

Here, information to be stored in the accumulation unit may be such information as including a destination of a notification, or including a transfer destination of the notification.

Here, the image forming apparatus may further have: a halting judgment unit for judging whether the print job satisfies a predetermined condition, where the halting judgment unit judges in the affirmative when information regarding a destination of the completion notification is the same as information regarding a predetermined destination.

Here, “information regarding a destination” is a concept not only including a notification form (regarding the destination?) (“To”, “Cc”, “Bcc”, and the like when the notification is e-mail), but also including a type of the destination (e.g. PC, portable telephone, and portable terminal).

With the stated structure, it is possible to switch between whether to halt transmission of notification or not, (i.e. whether to use a collective notification or not), depending on a destination of the notification.

Here, the image forming apparatus may further have: a halting judgment unit for judging whether the print job satisfies a predetermined condition, where the halting judgment unit judges in the affirmative when a print result of the print job is the same as a predetermined print result.

With the stated structure, it is possible to switch between whether to halt transmission of notification or not (i.e. whether to use a collective notification or not), depending on a print result.

Here, the image forming apparatus may further have: a halting judgment unit for judging whether the print job satisfies a predetermined condition; and a cancellation judgment unit for judging whether the halt state should be cancelled, where the halting judgment unit judges in the affirmative when the print job completes within a predetermined time, and the cancellation judgment unit judges in the affirmative when the predetermined time has elapsed.

Here, the image forming apparatus may further have: a cancellation judgment unit for judging whether the halt state should be cancelled, where the cancellation judgment unit judges in the affirmative when a number of print jobs whose completion notification has not been transmitted due to the halt state has reached a predetermined number.

The image forming apparatus may further have: a cancellation judgment unit for judging whether the halt state should be cancelled, where the cancellation judgment unit judges in the affirmative when a predetermined time has elapsed after completion of the print jobs whose completion notification has not been transmitted due to the halt state.

Here, the image forming apparatus may further have: a cancellation judgment unit for judging whether the halt state should be cancelled, where the information regarding the destination of the completion notification is information about a group to which the destination belongs, and the halting judgment unit judges in the affirmative when the information regarding the destination of the completion notification is the same as information about a predetermined group, the cancellation judgment unit judges in the affirmative when a print job whose information regarding a destination of a completion notification is the same as the information about a predetermined group has been completed, and the collective notification unit transmits the collective notification to members constituting the predetermined group.

With the stated structure, it is possible to issue a notification for each group for example.

Here, a structure is also possible in which when the print job has not been successfully completed, the collective notification unit adds a notification about the unsuccessful completion of the print job, to the collective notification before transmission.

With the stated structure, when for example the print result of a print job indicates “abnormal ending”, it is possible to add, to the corresponding error notification, completion notification with respect to so-far completed print jobs. This helps reduce the number of notifications to be transmitted to the client terminal (or to the user).

In addition, so as to achieve the above object, a program of the present invention is a program for making an image forming apparatus execute processing, the image forming apparatus executing a print job according to a print instruction from a client terminal, and transmitting a completion notification of the print job to the client terminal, the processing having: halting processing of, when the print job satisfies a predetermined condition, creatinga halt state in which transmission of the completion notification is halted; and collective notification processing of, if the halt state is cancelled with a plurality of completion notifications being halted, transmitting the plurality of completion notifications as at least one collective notification, a number of the at least one collective notification being smaller than a number of the plurality of completion notifications.

### BRIEF DESCRIPTION OF THE DRAWINGS

These and other objects, advantages and features of the invention will become apparent from the following description thereof taken in conjunction with the accompanying drawings that illustrate a specific embodiment of the invention.

In the drawings:

FIG. 1 is a diagram showing an entire structure of a printing system relating to the first embodiment;

FIG. 2 is a block diagram showing a hardware structure of a client terminal relating to the first embodiment;

FIG. 3 is a diagram showing a software structure of the client terminal relating to the first embodiment;

FIG. 4 is a diagram showing a screen of a display in the activation of the display unit, relating to the first embodiment;

FIG. 5 is a diagram showing part of printing data to be transmitted to the MFP, relating to the first embodiment;

FIG. 6 is a block diagram showing a structure of the MFP, relating to the first embodiment;

FIG. 7 is a diagram showing a notification information management table, relating to the first embodiment;

FIG. 8 is a flowchart showing completion notification processing in the first embodiment;

FIG. 9 is a diagram illustrating the orders and contents of print jobs in an embodiment example, relating to the first embodiment;

FIGS. 10A, 10B, and 10c respectively show a notification management table in the embodiment example, relating to the first embodiment;

FIGS. 11A, 11B, 11C, 11D respectively show a notification management table in the embodiment example, relating to the first embodiment;

FIGS. 12A, 12B, 12C, 12D respectively show a notification management table in the embodiment example, relating to the first embodiment;

FIG. 13 is a diagram showing a flowchart for Step S27 in the first embodiment;

FIG. 14 is a block diagram showing a main control unit of an MFP in a first modification example;

FIG. 15 is a schematic diagram of a notification information management table of the first modification example;

FIG. 16 is a flowchart showing processing performed by a table monitor unit in the first modification example;

FIG. 17 is a flowchart showing completion notification processing in the first modification example;

FIG. 18 is a flowchart showing completion notification processing in the second modification example;

FIG. 19 a diagram showing a screen of a display in the activation of the display unit, relating to a second embodiment;

FIG. 20 is a diagram showing a part of printing data to be transmitted to an MFP, relating to the second embodiment;

FIG. 21 is a block diagram showing a structure of the MFP, relating to the second embodiment;

FIG. 22 shows an accumulation table in the second embodiment;

FIG. 23 shows a management table in the second embodiment;

FIG. 24 shows a notification management table in the second embodiment;

FIG. 25 is a flowchart showing processing performed by a job accumulation unit, relating to the second embodiment;

FIG. 26 is a flowchart showing processing performed by an e-mail notification control unit, relating to the second embodiment;

FIG. 27 is a flowchart showing completion notification processing in a third modification example;

FIG. 28 is a diagram showing how the grouping is performed in the fourth modification example;

FIG. 29 is a diagram showing an accumulation table relating to the fourth modification example;

FIG. 30 is a diagram showing a management table relating to the fourth modification example;

FIG. 31 is a diagram showing a notification management table relating to the fourth modification example;

FIG. 32 is a flowchart showing processing performed by an e-mail notification control unit relating to the fourth modification example;

FIG. 33 is a diagram showing a destination management table relating to a third embodiment;

FIGS. 34A, 34B, and 34C respectively show a destination management table, relating to the third embodiment;

FIG. 35 is a flowchart showing processing performed by an e-mail notification control unit of the third embodiment;

FIG. 36 is a block diagram showing an e-mail notification control unit of a fifth modification example;

FIG. 37 is a flowchart showing processing performed by a table creation unit of the fifth modification example;

FIG. 38 is a flowchart showing processing performed by a notification timing judgment unit of the fifth modification example;

FIG. 39 shows a destination management table relating to a sixth modification example; and

FIG. 40 shows a destination management table relating to a seventh modification example.

### DESCRIPTION OF THE PREFERRED EMBODIMENTS

The following describes an embodiment in which an MFP is adopted as the image forming apparatus of the present invention. Note that the MFP is one example of the image forming apparatus. There are other types of image forming apparatus, such as a printer, and a multifunction printer.

### First Embodiment

1. Entire Structure

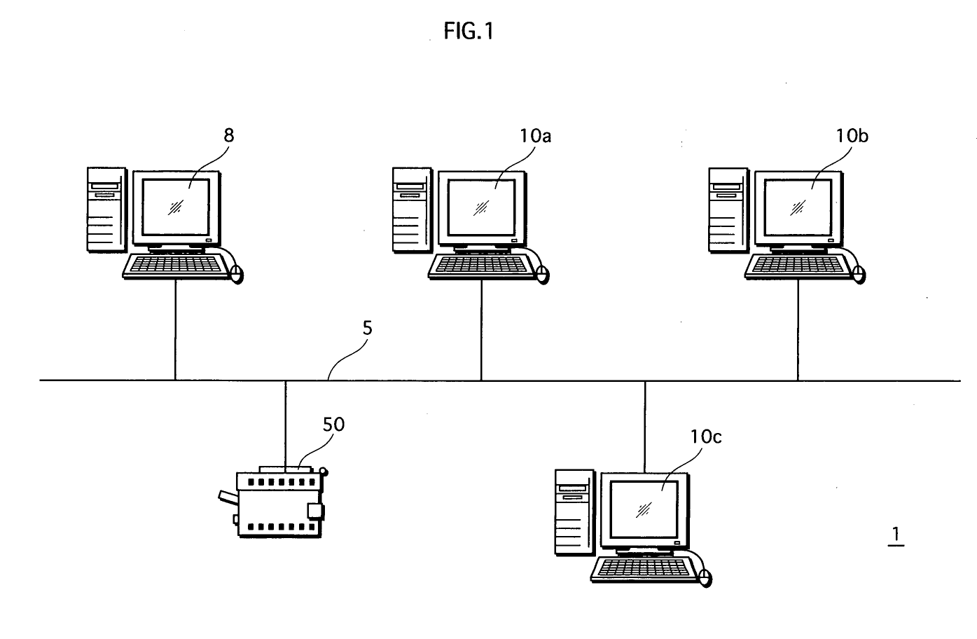

FIG. 1 is a diagram showing an entire structure of a printing system relating to the first embodiment.

As shown in this drawing, in a printing system 1, client terminals 10a, 10b, 10c, an MFP 50, and a mail server 8 are connected to each other via a network (LAN 5). Note that this printing system is one example, and the present invention is not limited to this printing system in terms of the number of client terminals, the number of MFPs, and the like.

The client terminals 10a, 10b, 10c, the MFP 50, and the mail server 8 are specifically connected to a LAN cable via a hub (not shown in the drawing), and are communicable to each other using a TCP/IP protocol. With this structure, the MPF50 for example is capable of receiving a print instruction from the client terminals 10a, 10b, and 10c.

The present printing system 1 is connected to the Internet, for example, via a router not shown in the drawing. According to this structure, when the MFP 50 has completed a print job according to a print instruction received from any of the client terminals 10a, 10b, and 10c, the MFP 50 transmits e-mail indicating the print job completion to a corresponding client terminal, for example.

Note that this e-mail is occasionally a completion notification (or “notification” in the present invention), and occasionally a collective completion notification (or “completion notification” in the present invention). Where it simply states “completion notification”, this may mean a completion notification, or a collective completion notification, depending on the context.

Note that the mail server 8 functions as an SMTP (simple mail transfer protocol) server in transmission of e-mail issued from any of the client terminals 10a, 10b, 10c, and the MFP 50, and functions as a POP (post office protocol) server in reception of e-mail.

2. Client Terminal

As follows, the client terminals 10a, 10b, and 10c are described. The three client terminals are basically the same in structure and the like, and so are collectively referred to as “client terminal 10” in the following explanation.

(1) Hardware Structure

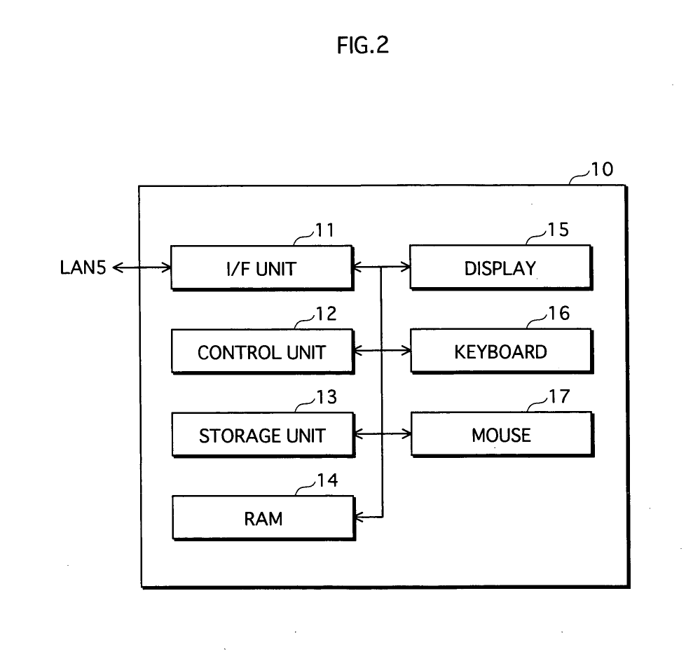

FIG. 2 is a block diagram showing a hardware structure of a client terminal relating to the first embodiment.

As shown in this drawing, the client terminal 10 is comprised of: an interface (I/F) unit 11, a control unit 12, a storage unit 13, a RAM 14, a display 15, a keyboard 16, a mouse 17, and the like. An example of the client terminal 10 is a personal computer (PC).

The I/F unit 11 is an interface for connecting to the LAN 5 (e.g. a LAN card, a LAN board).

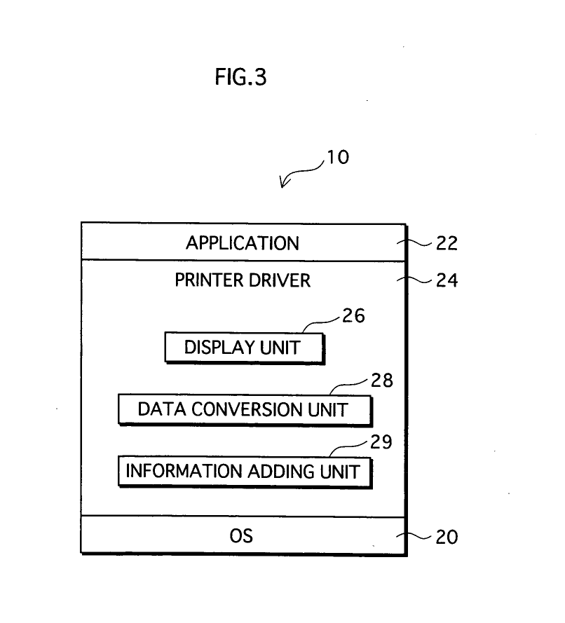

The storage unit 13 is a hard disk, for example, and stores therein an operating system (OS) 20 (see FIG. 3), an application 22, a printer driver 24, and so on. The printer driver 24 is used in requesting a printing to the MFP 50.

The RAM 14 offers a work area for various types of processing executed by the control unit 12. The control unit 12 is a CPU. The control unit 12 controls contents to be displayed on the display 15, and receives information inputted through the keyboard 16 and the mouse 17. In addition, the control unit 12 executes the functions of the OS 20 stored in the storage unit 13, and the like.

(2) Software Structure

FIG. 3 is a diagram showing a software structure of the client terminal.

As shown in this drawing, in the client terminal 10, the following software is installed: an OS 20, an application 22, a printer driver 24, as well as a display driver and the like not shown in the drawing.

The OS 20 corresponds to a network, and is basic software for a user of the client terminal 10 to operate the PC. The OS 20 performs management directed to the storage unit 13, the RAM 14, and the like, such as memory management and file management such as storing/reading of files.

The application 22 operates on the OS 20, and includes many types such as for the purpose of document creation, graphics creation, and table creation with computing power. The application 22 is installed via the OS 20, and is stored in the storage unit 13.

The printer driver 24 controls a printing outputting that is executed in the MFP 50. The printer driver 24 includes a display unit 26, a data conversion unit 28, and an information adding unit 29. When for example a user issues a print instruction on the application 22, the printer driver 24 creates printing data storing printing-related information and data for image forming and so on, and transmits the printing data to the MFP 50.

The data conversion unit 28 converts the printing data created in the application 22 that is in a format unique to the application 22, into data in a print description language (PDL) format, for example. In the following description, the printing data is explained to include both of printing-related information and data used in actual printing.

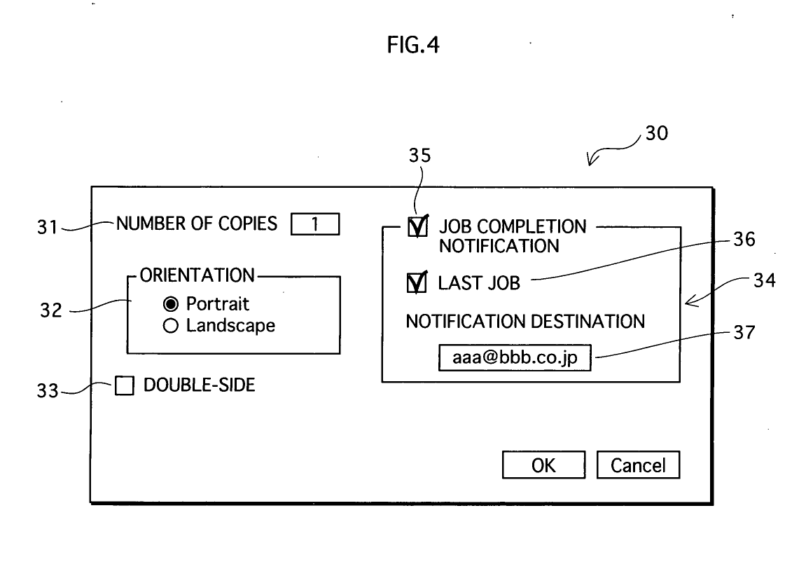

FIG. 4 is a diagram showing a screen of a display in the activation of the display unit.

The display unit 26 displays on the display 15 a prompt screen 30 for prompting a user to input printing-related information (hereinafter, simply “printing information”). As shown in FIG. 4, the prompt screen 30 contains such fields as: “number of copies” field 31; “orientation” field 32 for receiving orientation of printing paper; “double-side” field 33 for receiving a request for double-side printing; and “notification information” field 34 for receiving completion-notification related information (hereinafter simply referred to as “notification information”).

The notification information field 34 has: “job completion notification” sub-field 35 for receiving information on whether a completion notification should be transmitted upon completion of the print job; “last job” sub-field 36 for receiving a specification on whether the print job is the last one of sequential print jobs (i.e. indicating that there is no print job to be received subsequent to this print job); and “notification destination” sub-field 37 for inputting a destination of the completion notification, if the job completion notification sub-field 35 is marked in the affirmative (“ON”).

Concretely, the example of FIG. 4 indicates as follows. The number of copies is “1”, the orientation indicates “Portrait” (longitudinal), and “double-side” printing is not specified (“OFF”). Furthermore in the notification information field 34, the job completion notification is set “ON”, which requires that the MFP 50 transmit a completion notification upon completion of the print job (and the client terminal 10 will receive the completion notification). The notification destination of the completion notification is specified as “aaa@bbb.co.jp”.

Each piece of information input in the prompt screen 30 is transmitted to the MFP 50, by being stored in the printing data 40.

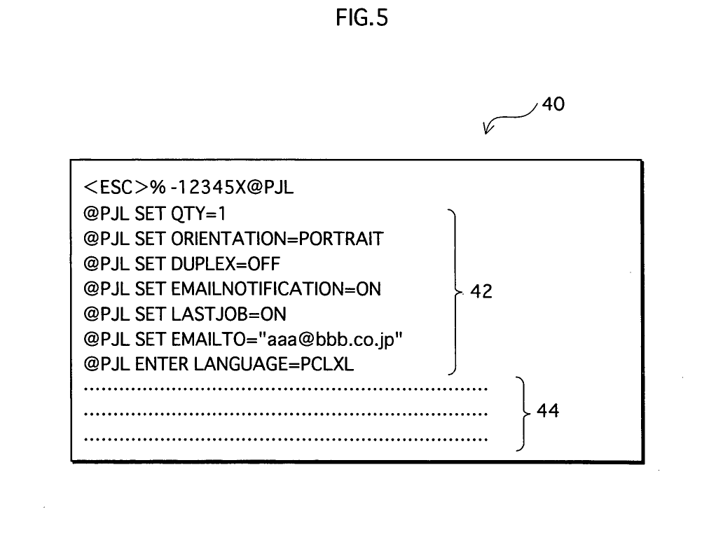

FIG. 5 is a diagram showing part of printing data to be transmitted to the MFP.

As shown in FIG. 5, the printing data 40 contains a substance portion 44 and a header portion 42. The substance portion 44 stores data for image forming, whereas the header portion 42 stores printing information and notification information.

Here, the header portion 42 stores the printing information in the following manner: “@PJL SET QTY=1” indicating that the number of copies is marked as “1”; “@PJL SET ORIENTATION=PORTRAIT” indicating that the paper orientation should be “Portrait”; and “@PJL SET DUPLEX=OFF” indicating that the double-side printing is OFF.

Meanwhile, the notification information is stored subsequent to the printing information in the header portion 42 in the following manner: “@PJL SET EMAILNOTIFICATION=ON” indicating that a job completion notification, being notification information is ON; “@PJL SET LASTJOB=ON” indicating that the “last job” is ON; and “@PJL SET EMAILTO=“aaa@bbb.co.jp”, indicating the notification destination.

Note that if “@PJL SET LASTJOB=ON”, it indicates that there is no subsequent print job to this print job. This information corresponds to “last-job information” of the present invention. Conversely, if “@PJL SET LASTJOB=OFF”, it indicates that another print job is to be received subsequent to this print job. This information corresponds to “sequential information” in the present invention.

3. MFP

The MFP relating to the present embodiment has a function of executing a print job according to a print instruction received from a client terminal, and of transmitting a completion notification of the print job to the client terminal. In particular, the MFP, when the print job satisfies a predetermined condition, creates a halt state in which transmission of the completion notification is halted, and if the halt state is cancelled with a plurality of completion notifications being halted, the MFP transmits the plurality of completion notifications as one collective notification.

In addition, so as to realize the above-stated function, the MFP has a program for operating the MFP in the above-stated way. Specifically, the program is for realizing: halting processing of, when the print job satisfies a predetermined condition, creating a halt state in which transmission of the completion notification is halted; and collective notification processing of, if the halt state is cancelled with a plurality of completion notifications being halted, transmitting the plurality of completion notifications as one collective notification.

(1) Hardware Structure

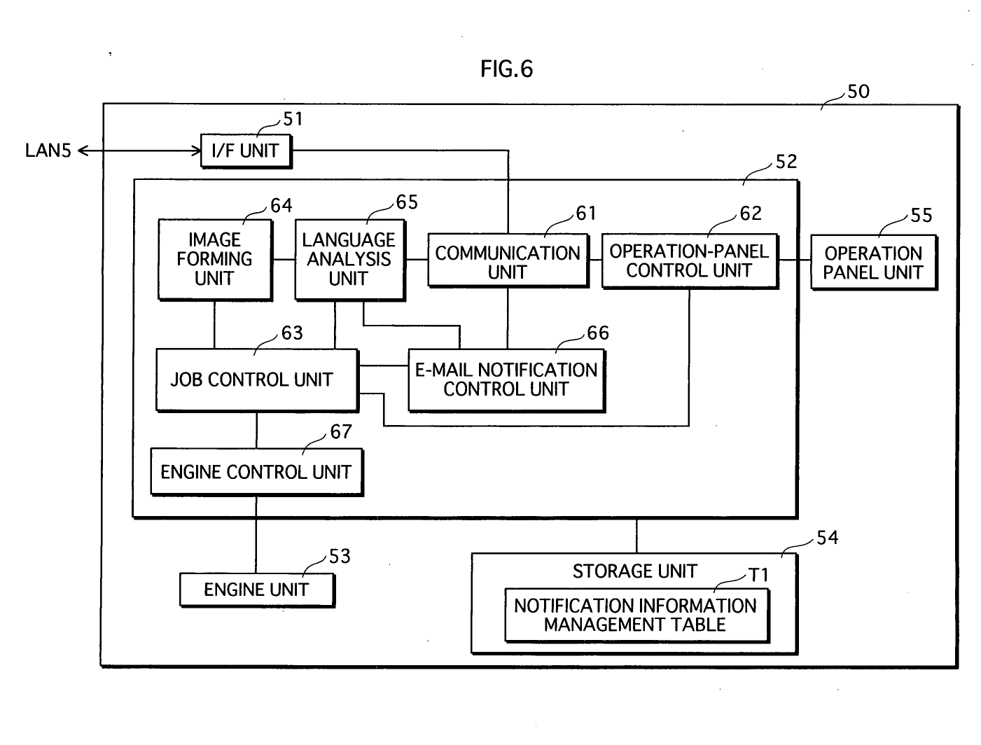

FIG. 6 is a block diagram showing a structure of the MFP.

As shown in FIG. 6, the MFP 50 is comprised of: an

interface (I/F) unit 51; a main control unit 52; an engine unit 53; a storage unit 54; an operation panel unit 55, and the like.

The I/F unit 51 is an interface for connecting to the LAN 5 (e.g. a LAN card, a LAN board). The operation panel unit 55 is, for example, equipped with a touch panel unit, a ten-key unit, an input unit, or the like (not shown in the drawing).

The touch panel unit is used for the following purposes, for example: inputting various types of setting relating to the MFP 50 in accordance with the display; displaying completion of a print job; and displaying an error message caused during execution of a print job.

Note that the various types of setting, mentioned above, include communication setting necessary for notifying a client terminal of job completion by e-mail, and network setting (e.g. IP address). Information inputted via the touch panel unit is outputted to the main control unit 52. Then, in accordance with the inputted information, the main control unit 52 instructs the operation panel unit 55 to control the touch panel unit to present a next display necessary for the next input operation.

The storage unit 54 performs the following for example: storing various types of data; offering a work area for various types of processing executed by the main control unit 52; and

storing a notification information management table T1 that stores pieces of notification information, and other tables. The notification information management table T1 is detailed later.

The engine unit 53 adopts a publicly-known electrophotographic method, for example. The main task of the engine unit 53 is to supply printing paper from a printing bin, transfer an image onto the paper, and discharge the paper to a discharge bin, in accordance with a print-job related instruction issued from the main control unit 52.

The main control unit 52 is comprised of: a communication unit 61; an operation-panel control unit 62, a job control unit 63, an image forming unit 64, a language analysis unit 65, an e-mail notification control unit 66, and an engine control unit 67. An example of the main control unit 52 is a CPU.

The communication unit 61 mainly controls the I/F unit 51. The operation-panel control unit 62 mainly controls the operation panel unit 55. The job control unit 63 mainly controls print jobs. The engine control unit 67 mainly controls the engine unit 53.

The language analysis unit 65 analyzes printing data having been received from a client terminal. The image forming unit 64 converts data (e.g. in PDL format) stored in the substance portion 44 of the received printing data 40, into data in a predetermined format (e.g. bit-mapped image data).

The e-mail notification control unit 66 performs such functions as follows: upon completion of a print job, issuing a completion notification to a client terminal 10 having issued the print job; and if a client terminal has sequentially issued print jobs, informing the client terminal of completion of these print jobs by means of a collective completion notification, after completion of these print jobs and on condition that there is no subsequent print job. Note that the e-mail notification control unit 66 executes these functions by referring to the notification management table T1 stored in the storage unit 54.

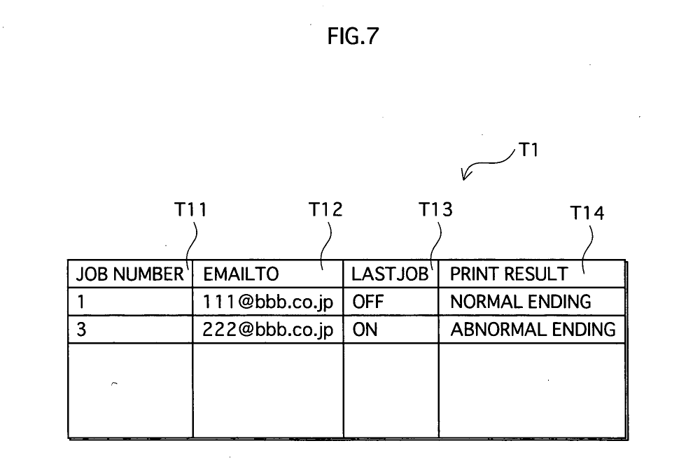

FIG. 7 is a diagram showing a notification information management table.

As shown in this drawing, the notification information management table T1 has four columns: “job number” column T11; “EMAILTO” column T12; “LASTJOB” column T13; and “print result” column T14. Note that the information in the EMAILTO column T12 and in the LASTJOB column T13 has been stored in the header portion 42 of the printing data 40.

The job number column T11 indicates job numbers of the executed print jobs (i.e. print jobs received by the MFP 50), such as “1” and “3”. The EMAILTO column T12 indicates information stored as the “@PJL SET EMAILTO=” in the header portion 42, and indicates 111@bbb.co.jp and 222@bbb.co.jp, for example. Note that the mail address is occasionally referred to as “EMAILTO name”.

The LASTJOB column T13 indicates information having been stored in the “@PJL SET LASTJOB=”. It specifically indicates “OFF” and “ON” for example, for indicating whether the print job corresponding to the job number is the last job of all the print jobs sequentially received from one client terminal 10.

Finally, the print result column T14 indicates a print result of a print job (e.g. “normal ending”, “abnormal ending”).

(2) Print Job Processing (Outline)

Mainly using FIG. 6, the processing of the MFP 50 after reception of a print instruction from a client terminal 10 is described as follows.

In the printing data 40 transmitted from the client terminal 10, data in the substance portion 44 is described in PDL format (see FIG. 5). This printing data 40 is received in the I/F unit 51, and then is outputted to the language analysis unit 65 via the communication unit 61.

The language analysis unit 65 analyzes printing data 40 having been received, and outputs the data necessary for image forming to the image forming unit 64, and the information necessary in executing the print job to the job control unit 63. The language analysis unit 65 further outputs completion-notification related information to the e-mail notification control unit 66. Here, the data necessary for image forming corresponds to data stored in the substance portion 44, and the information necessary in executing the print job corresponds to printing data (e.g. number of copies, orientation, information on whether double-side printing or not) stored in the header portion 42. Further, the completion-notification related information corresponds to notification information stored in the header unit 42.

The image forming unit 64 converts the received data in PDL format in to bit-mapped image data, for example, and outputs the bit-mapped data to the job control unit 63. Hereinafter, the bit-mapped data is called “image data”.

The job control unit 63 temporarily stores, in the storage unit 54, the image data and the printing information. In addition, the job control unit 63 issues a print instruction to the engine control unit 67 to print the image data according to the printing information.

The engine control unit 67 drives the engine unit 53 to form an image on paper, and outputs the print result to the job control unit 63 upon completion of the print job. The job control unit 63, upon reception of the print result, outputs the print result to the operation-panel control unit 62 and to the e-mail notification control unit 66.

Upon reception of the print result, the operation-panel control unit 62 displays the received print result on the operation panel unit 55, and the e-mail notification control unit 66 transmits e-mail, as a completion notification, to a client terminal 10 having transmitted a print instruction of the completed print job.

In this way, the processing of the MFP 50 upon reception of a print instruction from a client terminal 10 completes. More specifically, the processing of executing a print job, the processing of displaying a print result on the operation panel unit 55, the processing of transmitting a completion notification of the print job to the client terminal 10, and the like, complete.

(3) Notification of Processing Result

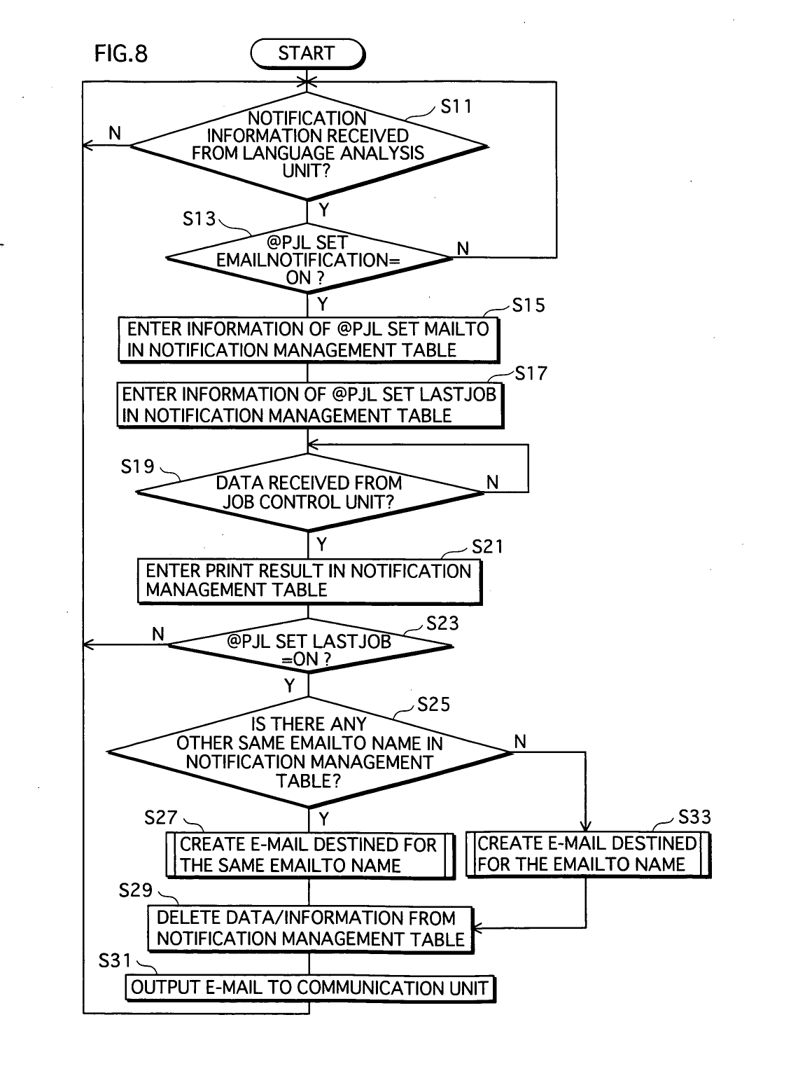

FIG. 8 is a flowchart showing completion notification processing.

As shown in FIG. 8, the e-mail notification control unit 66 judges whether notification information is received from the language analysis unit 65 (Step S11). The notification information corresponds to information of “@PJL SET LASTJOB” and “@PJL SET EMAILTO” (see FIG. 7), as well as information of “@PJL SET EMAILNOTIFICATION”.

When notification information is judged to have been received (Step S11:Y), the control proceeds to Step S13, where it is judged whether a corresponding client terminal is requesting a completion notification. Specifically, this is judged by checking whether “@PJL SET EMAILNOTIFICATION” in the received notification information is set “ON” or “OFF”. On the contrary, when the judgment in Step S11 is in the negative (Step S11:N), the judgment in Step S11 is repeatedly performed until notification information is received.

When “@PJL SET EMAILNOTIFICATION” is confirmed “ON” in Step S13 (Step S13:Y), meaning that the user is requesting the completion notification, the information (EMAILTO name) of the “@PJL SET EMAILTO”, such as 111@bbb.co.jp, is entered in the EMAILTO column T12 of the notification information management table T1, as the destination of the completion notification (Step S15). Then as shown in FIG. 7, the information of “@PJL SET LASTJOB” indicating whether the print job is the last job (“OFF” in this example) is entered in the LASTJOB column T13 of the notification information management table T1 (Step S17). After this, the control proceeds to Step S19.

When the “@PJL SET EMAILNOTIFICATION” is confirmed “OFF” in Step S13 (Step S13:N), meaning that the user is not requesting the completion notification, there is no need for notification, and so the control returns to Step S11.

Next, in Step S19, it is judged whether data indicating completion of a print job is received from the job control unit 63. The data indicating completion is data to be received by the job completion unit 63 from the engine control unit 67, upon completion of a print job whose print instruction has been issued from the job control unit 63 to the engine control unit 67. For example, a print result transmitted upon completion of a print job can be employed as the data indicating completion.

If the data indicating completion (e.g. print result) is judged to have been received in Step S19, it means that the print job has been complete. Accordingly, as shown in FIG. 7, the received print result (e.g. “normal ending”) is entered in the print result column T14 of the notification information management table T1 (Step S21). Conversely, when the judgment of Step S19 has resulted in the negative (meaning that the print job has not been complete yet, Step S19:N), the control returns to Step S19 and waits till data indicating completion is received (i.e. the judgment in Step S19 is repeatedly performed until such data is received).

Upon completion of entering the print result in the notification information management table T1 in Step S21, it is then judged whether “@PJL SET LASTJOB” is “ON” (Step S23). When “@PJL SET LASTJOB” is judged to be “OFF” (Step S23:N), this means that the print job just completed is not the last job, and so it is not necessary to transmit a completion notification to the client terminal 10 at the moment. Accordingly, the control returns to Step S11.

On the other hand, when “@PJL SET LASTJOB” is judged to be “ON” in Step S23 (Step S23:Y), it is then judged whether any other same EMAILTO name exists in the EMAILTO column T12 of the notification information management table T1 (Step S25).

When the judgment of Step S25 is in the affirmative, e-mail indicating completion of the corresponding print jobs, destined for the same EMAILTO name, is created (Step S27). Then all the data/information relating to the created e-mail is deleted from the notification management table T1 (Step S29), and the created e-mail is outputted to the communication unit 61 (Step S31).

When the judgment of Step S25 in the negative, e-mail indicating completion of the print job, destined for the EMAILTO name, is created (Step S33). Then all the data/information relating to the created e-mail is deleted from the notification management table T1 (Step S29), and the created e-mail is outputted to the communication unit 61 (Step S31).

(4) Embodiment Example

As follows, concrete processing performed in transmitting completion notifications to the client terminals 10 after print job completion is explained using an embodiment example.

A. Processing

The present embodiment example assumes a case where four print jobs are sequentially issued from the client terminals 10a, 10b, and 10c to the MFP 50.

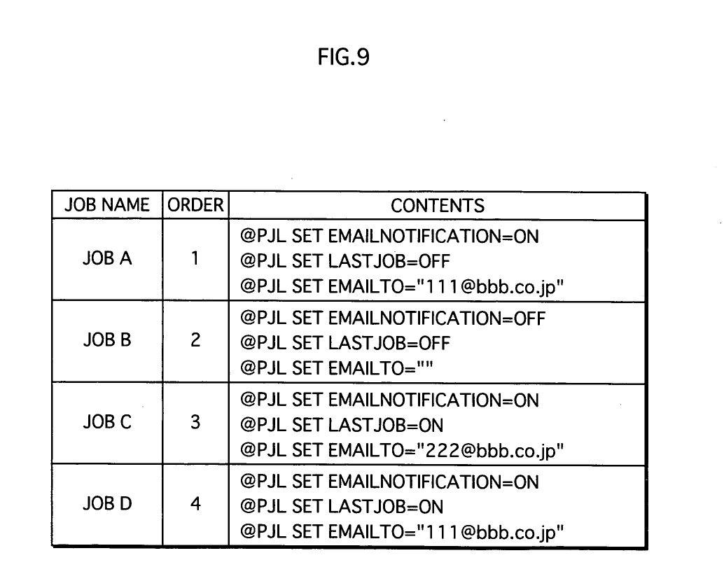

FIG. 9 is a diagram illustrating the orders and contents of the four print jobs in the present embodiment example.

The four print jobs respectively have names “job A”, “job B”, “job C”, and “job D”. The four print jobs are received (and executed) in the MFP 50 in the order of “job A”, “job B”, “job C”, and “job D”.

(a) With Regard to Job A

From FIG. 9, the following is known with regard to the job A: “@PJL SET EMAILNOTIFICATION” is set “ON”, and so the completion information is requested by the client terminal 10a; and “@PJL SET LASTJOB” is set “OFF”, and so the job A is not the last job.

In addition, since the “@PJL SET EMAILTO” (i.e. EMAILTO name) indicates 111@bbb.co.jp, the completion notification of the job A should be destined for this mail address.

(b) With Regard to Job B

With regard to the job B, the following is known from FIG. 9. That is “@PJL SET EMAILNOTIFICATION” is set “OFF”, and so the completion information is not requested by the client terminal 10b. In view of this, “@PJL SET LASTJOB” is set “OFF”, and the “@PJL SET EMAILTO” indicates blank (i.e. “ ”).

(c) With Regard to Job C

With regard to the job C, the following is known from FIG. 9: “@PJL SET EMAILNOTIFICATION” is set “ON”, and so the completion information is requested by the client terminal 10c; and “@PJL SET LASTJOB” is set “ON”, and so the job C is the last job.

In addition, since the “@PJL SET EMAILTO” (i.e. EMAILTO name) indicates 222@bbb.co.jp, the completion notification of the job C should be destined for this mail address.

(d) With Regard to Job D

With regard to the job D, the following is known from FIG. 9: “@PJL SET EMAILNOTIFICATION” is set “ON”, and so the completion information is requested by the client terminal 10a; and “@PJL SET LASTJOB” is set “ON”, and so the job D is the last job.

In addition, since the “@PJL SET EMAILTO” (i.e. EMAILTO name) indicates 111@bbb.co.jp, the completion notification of the job D should be destined for this mail address. Note that this EMAILTO name is the same as the EMAILTO name for the job A. This is why the print instruction for the job D is interpreted as being received from the client terminal 10a. This means that a plurality of print instructions are received from the client terminal 10a, and specifically constitutes a case of “another print instruction being received from one client terminal subsequent to one print instruction” in the present invention.

B. Processing for Completion Notification

As follows, a case of executing the four print jobs is described using FIG. 8.

(a) With Respect to Job a

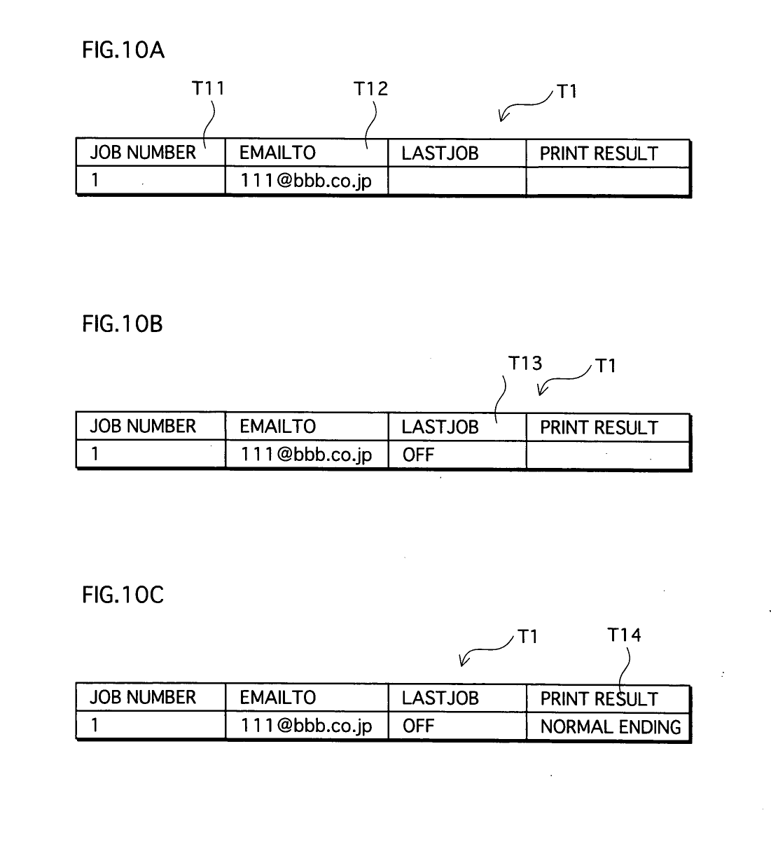

First, the e-mail notification control unit 66 judges that notification information for the print job A is received from the language analysis unit 65 (Step S11:Y). Then in Step S13, it is judged whether “@PJL SET EMAILNOTIFICATION” in the received notification information indicates “ON”. Here, it is “ON”, and so in Step S15, 111@bbb.co.jp is entered in the EMAILTO column T12 of the notification information management table T1 (FIG. 10A). Further, in Step S17, “OFF” is entered in the LASTJOB column T13 of the notification information table T1 (FIG. 10B).

In Step S19, if data indicating completion (print result) is judged to have been received from the job control unit 63, “normal ending”, as the print result, is entered in the print result column T14 of the notification information management table T1 in Step S21 (see FIG. 10C).

Next, since “@PJL SET LASTJOB” of the job A indicates “OFF”, Step S23 results in “N”, and the control returns to Step S11.

(b) With Respect to Job B

In the above description of (a), the processing for the job A completes. Following this, the processing for the job B starts.

First, the e-mail notification control unit 66 judges that notification information for the print job B is received from the language analysis unit 65 (Step S11:Y). Then in Step S13, it is judged whether “@PJL SET EMAILNOTIFICATION” in the received notification information indicates “ON”. Here, it is “OFF”, and so the control returns to Step S11. In other words, even when the print job for the job B completes, the client terminal 10b does not require the completion notification, and so it is unnecessary to enter the notification information and the like to the notification information management table T1. This is why the control returns to Step S11. Note that the notification information management table T1 will remain in the same state as shown in FIG. 10C even after the processing for the job B has ended.

(c) With Respect to Job C

In the above description of (b), the processing for the job B completes. Following this, the processing for the job C starts.

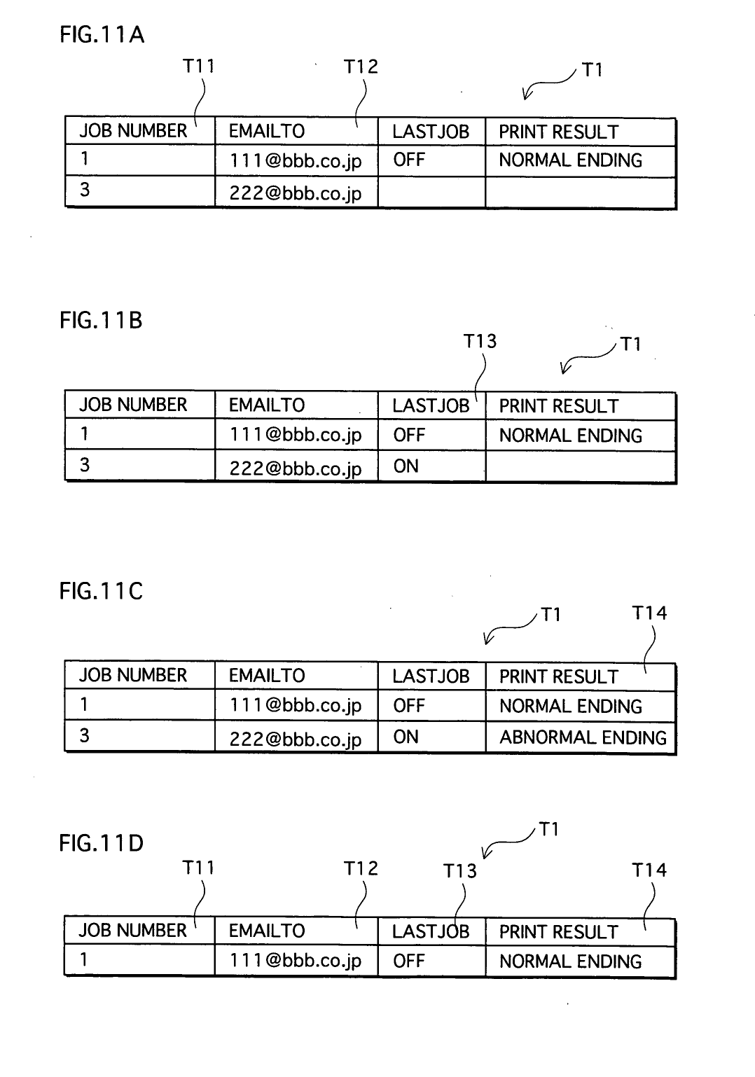

First, the e-mail notification control unit 66 judges that notification information for the print job C is received from the language analysis unit 65 (Step S11:Y). Then in Step S13, it is judged whether “@PJL SET EMAILNOTIFICATION” in the received notification information indicates “ON”. Here, it is “ON”, and so in Step S15, 222@bbb.co.jp is entered in the EMAILTO column T12 for the job number “3” of the notification information management table T1 (FIG. 1A). Further, in Step S17, “ON” is entered in the LASTJOB column T13 for the job number “3” of the notification information table T1 (FIG. 11B).

In Step S19, if data indicating completion (print result) is judged to have been received from the job control unit 63, “abnormal ending”, as the print result, is entered in the print result column T14 for the job number “3” of the notification information management table T1 in Step S21 (see FIG. 11C). Here, it can be seen that an error has occurred in execution of the job C.

Next, since “@PJL SET LASTJOB” of the job C indicates “ON”, Step S23 results in “Y”, and the control proceeds to Step S25, where it is judged whether any other same EMAILTO name exists in the EMAILTO column T12 of the notification information management table T1.

Here, no other same EMAILTO name can be found, the control proceeds to Step S33, and e-mail destined for 222@bbb.co.jp is created. Then as shown in FIG. 11D, all the data/information relating to job number “3” is deleted from the notification management table T1 (Step S29), and the created e-mail is outputted to the communication unit 61 (Step S31).

In this way, a notification indicating completion of the print job for the job C is transmitted to the client terminal 10c by the e-mail.

(d) With Respect to Job D

In the above description of (c), the processing for the job C completes. Following this, the processing for the job D starts.

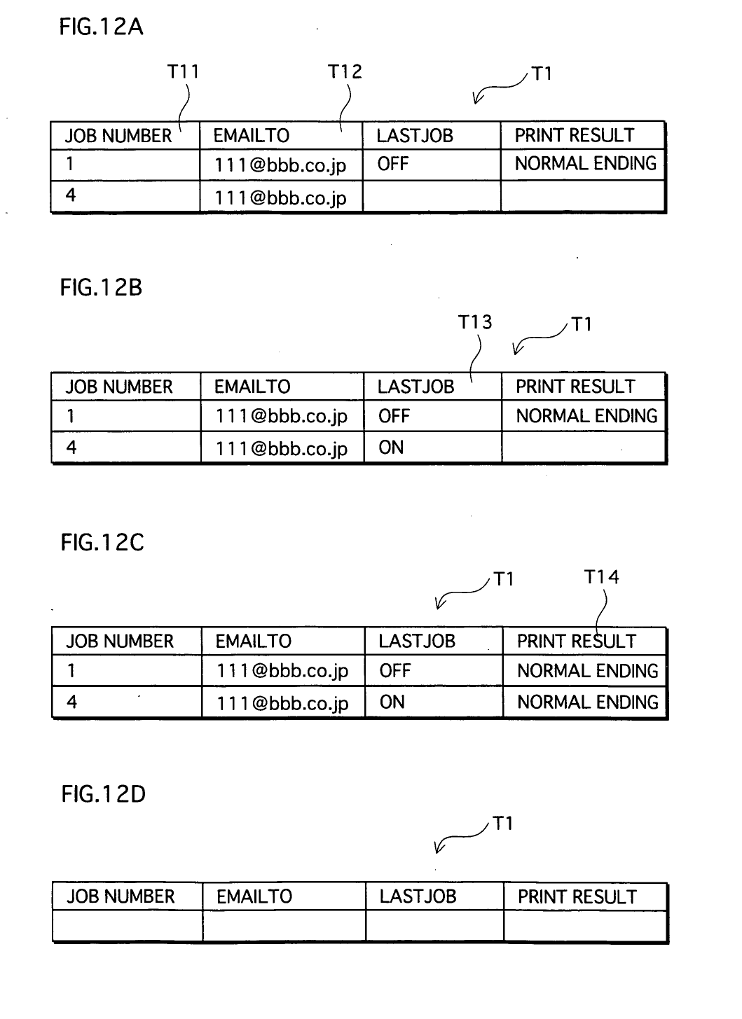

First, the e-mail notification control unit 66 judges that notification information for the print job D is received from the language analysis unit 65 (Step S11:Y). Then in Step S13, it is judged whether “@PJL SET EMAILNOTIFICATION” in the received notification information indicates “ON”. Here, it is “ON”, and so in Step S15, 111@bbb.co.jp is entered in the EMAILTO column T12 for the job number “4” of the notification information management table T1 (FIG. 12A). Further, in Step S17, “ON” is entered in the LASTJOB column T13 for the job number “4” of the notification information table T1 (FIG. 12B).

In Step S19, if data indicating completion (print result) is judged to have been received from the job control unit 63, “normal ending”, as the print result, is entered in the print result column T14 for the job number “4” of the notification information management table T1 in Step S21 (see FIG. 12C).

Next, since “@PJL SET LASTJOB” of the job D indicates “ON”, Step S23 results in “Y”, and the control proceeds to Step S25, where it is judged whether any other same EMAILTO name exists in the EMAILTO column T12 of the notification information management table T1.

Here, the job number “1” has the same EMAILTO name (i.e. mail address) as that of the job number “4”, and so the control proceeds to Step S27, and e-mail destined for 111@bbb.co.jp is created. Here this e-mail corresponds to a collective completion notification in the present invention. Then as shown in FIG. 12D, all the data/information relating to job numbers “1” and “4” is deleted from the notification management table T1 (Step S29), and the created e-mail is outputted to the communication unit 61 (Step S31).

In this way, a collective completion notification indicating completion of both of the job A and the job D is transmitted to the client terminal 10a by the e-mail.

(e) E-Mail Creation

Here, Step S27 is explained in the context of the above embodiment example.

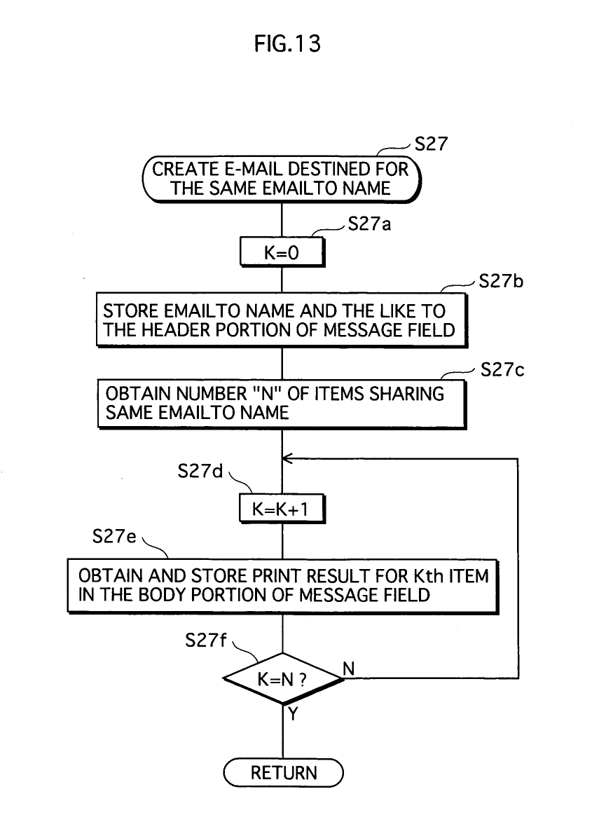

FIG. 13 is a diagram showing a flowchart for Step S27.

First, a variable “K” is cleared to 0 (Step S27a). Then the MAILTO name (a completion notification destination), a mail address of the MFP (a transmission source), and the like are stored in the header portion of the message field of the mail (Step S27b).

After the information is stored in the header portion, the number N of items sharing the same EMAILTO name (i.e. 111@bbb.co.jp) is counted using the notification management table T1 (Step S27c). Concretely, the EMAILTO column T11 is checked to for any item having the same EMAILTO name. Then, N is obtained by adding up the number of the found items having the same EMAILTO name, for example.

Next, K is set as 1 (Step S27d), and “normal ending” stored in the print result column T14 for the job number “1” being the first item sharing the same EMAILTO name (111@bbb.co.jp) is obtained and stored in the body portion of the message filed (Step S27e).

Then, in Step S27f, whether the variable K matches the number N of the EMAILTO name is judged. Here, K=1 and N=2, and so K and N do not match. Therefore the control proceeds to Step S27d, and 1 is added to the variable K, to set K=2.

In Step S27e, “normal ending” stored in the print result column T14 for the job number “4” being the second item sharing the same EMAILTO name is obtained and stored in the body portion of the message field (Step S27e).

In Step S27f, again whether the variable K matches the number N of the EMAILTO name is judged. Here, K=2 and N=2, and so K and N match. Therefore the control returns to Step S29 of FIG. 8.

(5) Summary

As detailed in the above embodiment example, in the present embodiment, when the client terminal 10 requests a completion notification for example, even where there is only one print instruction, it is possible to transmit a completion notification indicating the completion of the corresponding print job. Therefore, even when a client terminal 10 is in a remote place from the MFP 50, a user can go to the MFP 50 to fetch the printout after reception of the completion notification, just as in the conventional case.

In addition, when a plurality of print jobs are sequentially issued from the same client terminal 10, a completion notification is not transmitted even part of the print jobs has been complete (creation of a halt state). Instead, after completion of the last print job (“last job”) of the print jobs, a collective completion notification for all the print jobs is transmitted.

With this structure, when the client terminal has issued a plurality of sequential print instructions, it will not receive a completion notification each time one print job completes. Therefore, the user is relieved of the annoyance of receiving the same number of job completion notifications as the number of the requested print jobs.

Furthermore, the number of completion notifications to be transmitted on the network is lessened, which contributes to reduction of network traffic load.

4. Other Notes

In the above embodiment, the e-mail notification control unit 66 was explained to transmit a completion notification after completion of the last job. To be more specific, in the example of FIG. 8, a completion notification is transmitted after data indicating completion (print result) of a print job has been received from the job control unit 63 in Step S19, and after confirming that the print job is the last job in Step S23.

However, the present invention is not limited to this structure, and may transmit a completion notification even before completion of the last print job (last job), under a predetermined condition.

As follows, a first modification example that relates to the above-described embodiment is described.

(1) First Modification Example

In the first modification example, when a predetermined time has passed after completion of a print job which is not the last job among print jobs whose completion notifications have the same destination, a collective completion notification is designed to be transmitted with respect to so-far completed print jobs, even if the last job has not been completed at the time.

A. Structure of MFP

The difference between the first modification example and the first embodiment lies in the main control unit and the notification information management table stored in the storage unit. For the other structures, the first modification example is the same as the first embodiment (e.g. the I/F unit 51, the engine unit 53, and the operation panel unit 55, etc.).

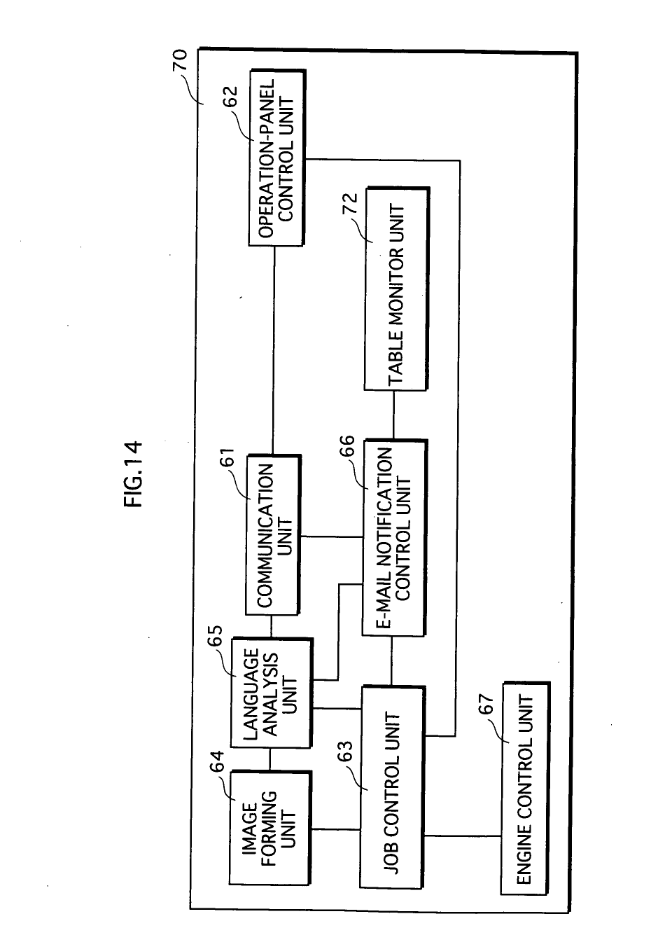

FIG. 14 is a block diagram showing the main control unit of the MFP in the first modification example.

As shown in FIG. 14, the main control unit 70 of the MFP has such a structure of having, in addition to the main control unit 52 of the first embodiment, a table monitor unit 72 connected to the e-mail notification control unit 66. Specifically, the main control unit 70 includes: a notification control unit 61, an operation-panel control unit 62, a job control unit 63, an image forming unit 64, a language analysis unit 65, an e-mail notification control unit 66a, an engine control unit 67 (the components so far are the same as those in the first embodiment), and a table monitor unit 72. Note that the e-mail notification control unit of the first modification example performs differently from the counterpart of the first embodiment, and so is assigned a reference number “66a” and not “66”.

The table monitor unit 72 monitors a time elapsed after completion of the print job performed the last. If the elapsed time becomes a predetermined time, the table monitor unit 72 notifies the e-mail notification control unit 66a of the print job.

B. Notification Information Management Table

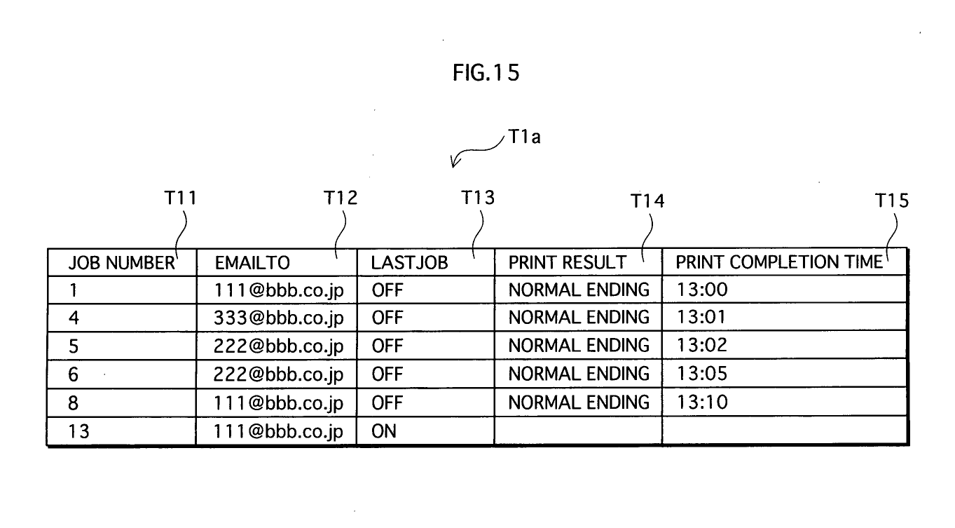

FIG. 15 is a schematic diagram of a notification information management table of the first modification example.

As shown in FIG. 15, the notification information management table T1a relating to the first modification example has five columns: “job number” column T11; “EMAILTO” column T12; “LASTJOB” column T13; “print result” column T14; and “print completion time” column T15. That is, the notification information management table T1a has the “print completion time” column T15, in addition to the same columns of the notification information management table T1.

Every time data indicating completion of a print job (print result) is received from the job control unit 63, the reception time, for example, is entered in this “print completion time” column T15. Note that the MFP includes therein a timer for counting the time, although the timer is not shown in the drawings.

C. Table Monitor Unit

(a) Processing

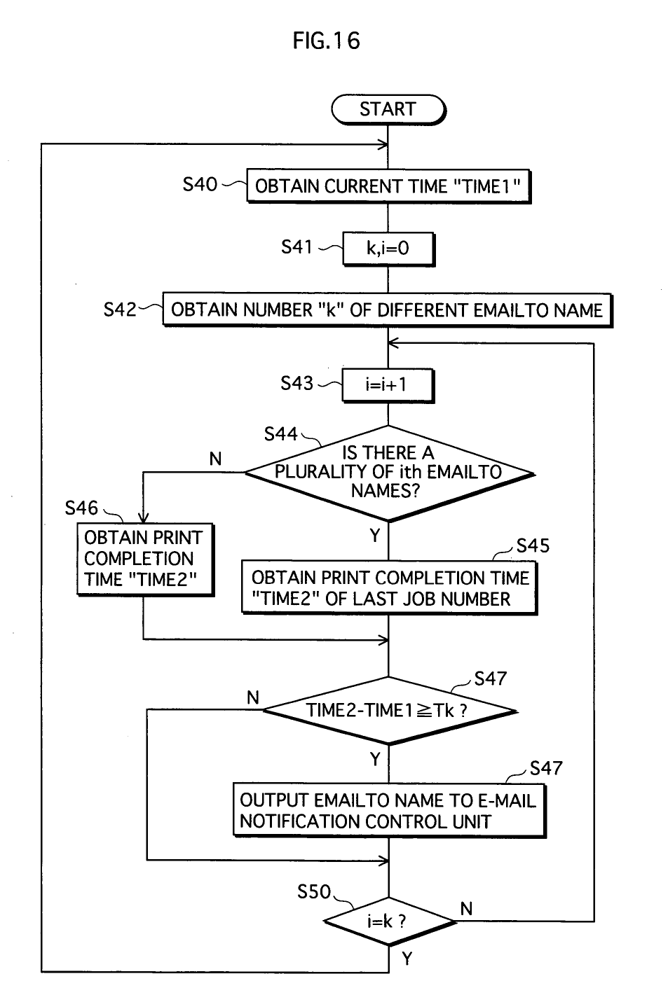

FIG. 16 is a flowchart showing processing performed by the table monitor unit.

As shown in FIG. 16, the table monitor unit 72 obtains a current time “TIME 1” for example from the timer (Step S40), clears “k” and “i” to 0 (Step S41), and obtains the number “k” of different EMAILTO names that the notification information management table T1a currently has (Step S42). In example of FIG. 15, the notification information management table T1a has three different EMAILTO names, i.e. 111@bbb.com.jp, 222@bbb.co.jp, and 333@bbb.co.jp, and so the obtained “k” is “3”.

Next, 1 is added to “i” (Step S43), and it is judged whether the notification information management table T1a has a plurality of ith EMAILTO names (i.e. whether there are a plurality of print jobs having the ith EMAILTO name) (Step S44). When this judgment is in the affirmative (Step S44:Y), the print completion time “TIME 2” for the print job completed the last of all the plurality of print jobs is obtained (Step S45). Specifically this print completion time TIME 2 is found in the print completion time T15 corresponding to the job number for the job completed the last in the job number column T11. Hereinafter, the job number for the job completed the last is sometimes referred to as “last job number”.

When the judgment of Step S44 is in the negative (Step S44:N), the print completion time TIME 2 of the print job having the EMAILTO name is obtained (Step S46).

When the print completion time TIME 2 is obtained in the above way, an elapsed time from the print job completion to the current time is calculated. Specifically, the elapsed time is a difference between the current time TIME 1 (obtained in Step S40) and the print completion time TIME 2 (obtained in Step S45 or Step S46) (i.e. “TIME 2−TIME 1”). In Step S47, whether this elapsed time is a predetermined time “Tk” or longer is judged.

If the judgment in Step S47 is in the affirmative (Step S47:Y), a notification, indicating that there is a completion notification to be transmitted, is outputted from the table monitor unit 72 to the e-mail notification control unit 66. In this example, the EMAILTO name is specifically transmitted as the notification.

Finally, it is judged whether the variable “i” matches the “k” indicating the number of different EMAILTO names (Step S50), and when the judgment is in the affirmative (Step S50:Y), the control returns to Step S40. When the judgment is in the negative (Step S50:N), the control proceeds to Step S43.

(b) Concrete Example

The above-described operation is detailed as follows using the notification information management table T1a. In this example, the current time TIME 1 is “13:20” and the predetermined time Tk is set as 15 minutes. In addition, as indicated above, an EMAILTO name is used as a notification from the table monitor unit 72 indicating that there is a completion notification to be transmitted.

There are three kinds of EMAILTO names, as described above, and so “k” in Step S42 is “3”.

The first EMAILTO name (i=1), i.e. 111@bbb.co.jp, exists in the job numbers “1” and “8”, meaning that there are a plurality of first EMAILTO names (i.e. there are a plurality of print jobs having the first EMAILTO name) (Step S44:Y). Then the print completion time “13:10” of the job (job number “8”) that completes the last of the two jobs is obtained. The obtained time “13:10” is “TIME 2” obtained in Step S45. The elapsed time calculated using the obtained print completion time TIME 2 (i.e. 13:20-13:10=10 minutes) is smaller than the predetermined time Tk (15 minutes) (Step S47:N), and so the control proceeds to Step S50. In Step S50, the variable i is “1”, and so is different from the value of “k”=3. Therefore the control proceeds to Step S43.

Next, the second EMAILTO name (i=2), i.e. 333@bbb.co.jp only exists in the job number “4”, meaning that there is only one second EMAILTO name (i.e. there is only one print job having the second EMAILTO name)(Step S44:N). Therefore the print completion time “13:01” corresponding to the job number “4” is obtained. The obtained time “13:01” is “TIME 2” obtained in Step S46. The elapsed time calculated using the obtained print completion time TIME 2 (i.e. 13:20-13:01=19 minutes) is greater than the predetermined time Tk (15 minutes) (Step S47:Y). Therefore in Step S49, this EMAILTO name is outputted to the e-mail notification control unit 66a, and then the control proceeds to Step S50. In Step S50, the variable i is “2”, and so is different from the value of “k”=3. Therefore, the control returns to Step S43.

Finally, the third EMAILTO name (i=3), i.e. 222@bbb.co.jp, exists in the job numbers “5” and “6”, meaning that there are a plurality of third EMAILTO names (i.e. there are a plurality of print jobs having the third EMAILTO name) (Step S44:Y). Then the print completion time “13:05” of the job (job number “6”) that completes the last of the two jobs is obtained.

The obtained time “13:05” is “TIME 2” obtained in Step S45. The elapsed time calculated using the obtained print completion time TIME 2 (i.e. 13:20−13:07=15 minutes) is the same as the predetermined time Tk (15 minutes) (Step S47:Y). Therefore in Step S49, this EMAILTO name is outputted to the e-mail notification control unit 66a, and then the control proceeds to Step S50. In Step S50, the variable i is “3”, and so is the same as the value of “k”=3. Therefore, the control returns to Step S40.

D. E-Mail Notification Control Unit

(a) Processing

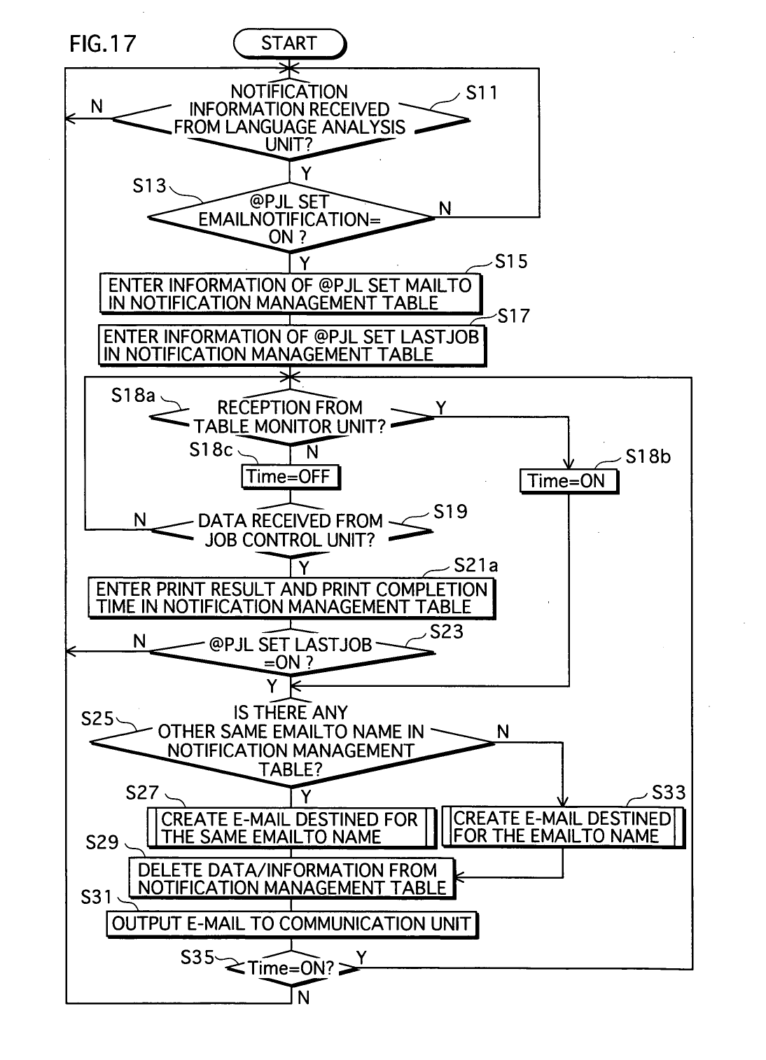

FIG. 17 is a flowchart showing completion notification processing in the first modification example.

The e-mail notification control unit 66a is able to perform the following function in addition to the functions of the e-mail notification control unit 66 of the first embodiment. That is, when receiving a notification from the table monitor unit 72 that there is a print job (or print jobs) having been completed for more than a predetermined time but whose completion notification has not been transmitted yet, the e-mail notification control unit 66a transmits a completion notification of the print job(s).

Specifically, the difference of the flowchart of FIG. 17 with respect to FIG. 8 is that Steps S18a, 18b, 18c, and 35 are newly added, with modification to Step S21a. As is clear from FIG. 17, the same steps as used in the first embodiment are assigned the same reference numbers. The steps in which the same processing is performed as in the first embodiment are not explained as follows.

In the first modification example, the e-mail notification control unit 66a judges whether a notification (EMAILTO name) is received from the table monitor unit 72 (Step S18a).

When the judgment is in the affirmative (Step S18a:Y), Time is set On (“Time=ON”) in Step S18b, and the control proceeds to Step S25. On the contrary, when the judgment is in the negative (Step S18a:N), Time is set OFF (“Time=OFF”), and the control proceeds to Step S19.

In Step S19, it is judged whether data indicating completion (print result) has been received from the job control unit 63. When the judgment of Step S19 in the affirmative, the print result and the print completion time are entered in the notification information management table T1a (Step S21a). When the judgment of Step S19 is in the negative, the control returns to Step S18a.

After Step S25, when the judgment of Step S18a is in the affirmative, creation of a completion notification and the like is performed based on the EMAILTO name. The concrete processing is the same as performed in Steps S27, S29, S31, and S33 of the first embodiment.

Then in Step S35, it is judged whether Time is ON, and if it is judged to be ON, the control returns to Step S18a, and if it is judged to be OFF, the control returns to Step S11.

(b) Concrete Example

As follows, the processing performed by the e-mail notification control unit 66a is briefly explained in line with the concrete example for explaining the table monitor unit 72 in the above section “C. Table monitor unit”.

In the following explanation, it is assumed that 333@bbb.co.jp and 222@bbb.co.jp are received from the table monitor unit 72, and that Time is ON.

First, a case where the received information is 333@bbb.co.jp is described.

When the judgment of Step S18a is in the affirmative, Time is set On (“Time=ON”) in Step S18b, and the control proceeds to Step S25, where it is judged whether there is any same EMAILTO name as 333@bbb.co.jp in the notification management table T1a.

In the example, there is no 333@bbb.co.jp exists in the notification management table T1a in FIG. 15. Therefore the control proceeds to Step S33, where e-mail destined for 333@bbb.co.jp is created, and the control proceeds to Steps S29 and S31. After this, since “Time=ON” in Step S35 (Step S35:Y), the control returns to Step S18a.

Next, a case where the received information is 222@bbb.co.jp is described.

When the judgment of Step S18a is in the affirmative, Time is set On (“Time=ON”) in Step S18b, and the control proceeds to Step S25, where it is judged whether there is any same EMAILTO name as 222@bbb.co.jp in the notification management table T1a.

In the example, there are two EMAILTO names same as 222@bbb.co.jp in the notification management table T1a in FIG. 15 (i.e. job numbers “5” and “6”). Therefore the control proceeds to Step S27, where e-mail destined for 222@bbb.co.jp indicating completion of the print jobs corresponding the job numbers “5” and “6” is created, and the control proceeds to Steps S29 and S31. Note that this e-mail indicating completion of both of the print jobs corresponding to the job numbers “5” and “6” is a collective completion notification. After this, since “Time=ON” in Step S35 (Step S35:Y), the control returns to Step S18a.

Here, there is no notification received from the table monitor unit 72, and so in Step S18a, it is judged that there is no EMAILTO name received from the table monitor unit 72 (Step S18a:N). Therefore Time is set OFF in Step S18c, and the processing thereafter is performed just as in the processing after Step S25 of FIG. 8. Since the final step S35 results in “Time=OFF”, and so the control returns to Step S11.

Also with the stated structure of the first modification example, it is possible to realize a function of reporting completion of a plurality of print jobs by means of one collective completion notification. Therefore when a client terminal has issued a plurality of sequential print jobs for example, it will not receive a completion notification each time one print job completes. Therefore, the user is relieved of the annoyance of receiving the same number of job completion notifications as the number of the requested print jobs. Furthermore, the number of completion notifications to be transmitted on the network is lessened, which contributes to reduction of network traffic load.

Furthermore, in a case where the user, who actually wants to receive a completion notification in completion of the last print job, has forgotten to check the last job sub-field 36 in FIG. 4, the completion notification will not be transmitted even after the completion of the last job. Therefore the corresponding printouts have a possibility of being left unattended in the discharge bin.

However, if such a structure as stated in the first modification example is adopted, even if the user forgot to check the last job sub-field 36, a completion notification will be assured to be transmitted for completed print jobs when a predetermined time has passed after the completion of the last job. Thus, the case as stated above will not occur.

In the above example with respect to the first modification example, when there are a plurality of print jobs having a same EMAILTO name, a completion notification will not be transmitted before a predetermined time has passed after completion of the last one of the plurality of print jobs. However, it is also possible to transmit a collective completion notification for print jobs having completed for a predetermined time even before the completion of the last one of the print jobs is not complete yet.

(2) Second Modification Example

In the above first embodiment, the MFP 50 is structured to transmit one collective completion notification with respect to so-far completed print jobs according to an instruction from the client terminal 10 (i.e. when the print job received from the client terminal 10 is “the last job”).

In the first modification example, when there are a plurality of sequential print jobs, a collective completion notification is transmitted to the client terminal 10 with respect to so-far completed print jobs when a predetermined time has passed after completion of a print job which is not the last job among print jobs whose completion notifications have the same destination (i.e. when it is judged that there is no subsequent print instructions). Here, a collective completion notification is transmitted regardless of whether the last job has been complete or not.

Meanwhile, in the second modification example, described as follows, when a print result of a print job indicates “abnormal ending”, a completion notification (or a collective completion notification when a plurality of print jobs are concerned) is to be transmitted if there is at least one print job having the same EMAILTO name as the EMAILTO name of the print job ended abnormally, regardless of completion of the last job.

In the components of the MFP of the second modification example, an e-mail notification control unit 66b is different from the e-mail notification control unit 66 of the first embodiment, in that the e-mail notification control unit 66b has a function of determining an occurrence of an error by checking a print result, and transmitting a completion notification when an error occurrence has been determined.

The following describes processing performed by the e-mail notification control unit 66b of the second modification example.

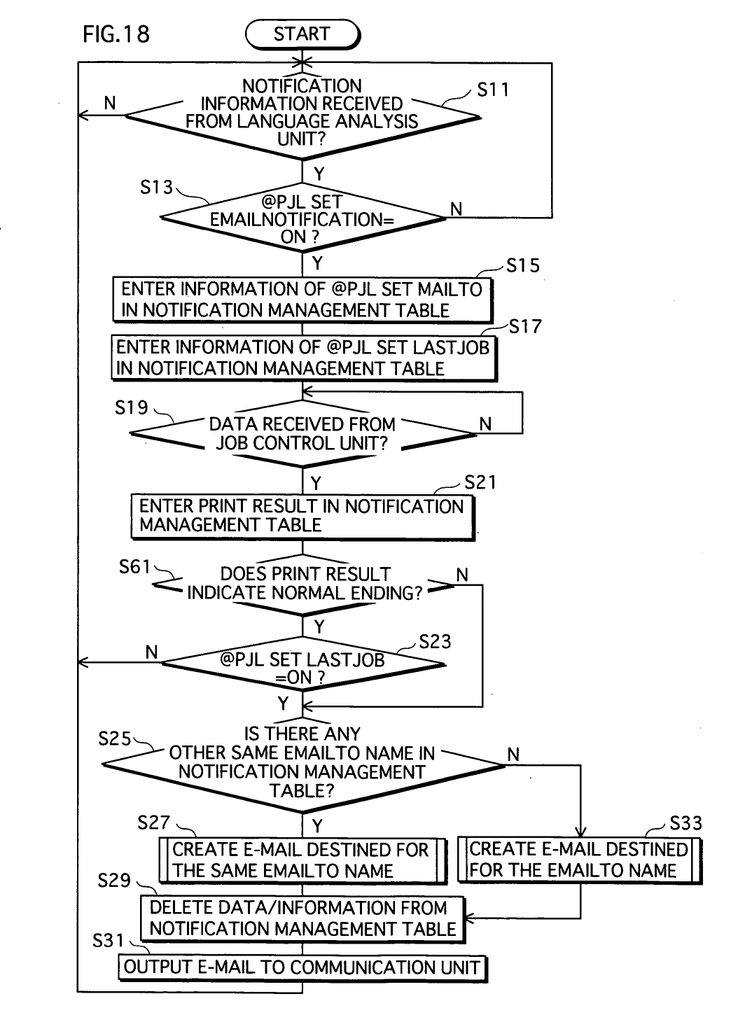

FIG. 18 is a flowchart showing completion notification processing in the second modification example.

The difference of the flowchart regarding the second modification example with the flowchart of FIG. 8 is that insertion of Step S61 between Step S21 and Step S23. Accordingly, in other steps of FIG. 18 than Step S61, the same contents as performed in the corresponding steps in FIG. 8 are performed.

The e-mail notification control unit 66b of the second modification example, when job completion information is received from the job control unit in Step S19, enters a corresponding print result in the notification information management table (Step S21). Then it is judged whether the print result indicates “normal ending” or not (Step S61).

When the judgment in Step S61 results in the affirmative (Step S61:Y), then the control proceeds to Step is S23 where the same processing as performed in the first embodiment is performed. Conversely, when the judgment in Step S61 results in the negative (Step S61:N), the control proceeds to Step S25 where the same processing as performed in the first embodiment (e.g. creation of e-mail which is a completion notification) is performed.

“normal ending” explained in the second modification example indicates a case where a print job has been completed without error occurrence, conversely, “abnormal ending” indicates a case where a print job was not able to be completed due to “out of paper”, “out of toner”, “paper jam”, and so on.

As indicated above, a completion notification in the second modification example includes at least a print result of a print job abnormally ended, but may additionally include information on another completed print job. This enables a user to immediately attend to such a case (e.g. issuing an instruction to the MFP with respect to the abnormally ended print job, and in the occurrence of a paper jam, fixing the paper jam).

### Second Embodiment

The completion notification in the first embodiment is such that one collective completion notification is transmitted to the client terminal 10 for so-far completed print jobs, upon completion of the last job set in accordance with a print instruction from the client terminal 10. However in the second embodiment, the MFP judges, according to a print-job operational state which is received from the client terminal, whether there are a plurality of sequential prinkt jobs, thereby transmitting one collective completion notification to the so-far completed print jobs.

In other words, the MFP in the second embodiment accumulates print jobs received from the client terminal (including a case of sequentially executing each print job right after accumulation thereof). Each time a print job completes, if there is any accumulated print job(s) which has the same EMAILTO name as the completed print job, after the completion of the accumulated print job(s), the MFP of the second embodiment transmits a collective completion notification for the print jobs destined for the same EMAILTO name.

1. Client Terminal

The client terminal is basically the same as in the first embodiment, except for a slight difference in the structure of the printer driver. Specifically, the difference of the printer driver is attributable to the difference in information to be stored in the header portion of printing data to be transmitted from the client terminal to the MFP (i.e. whether the header portion includes information relating to the last job or not).

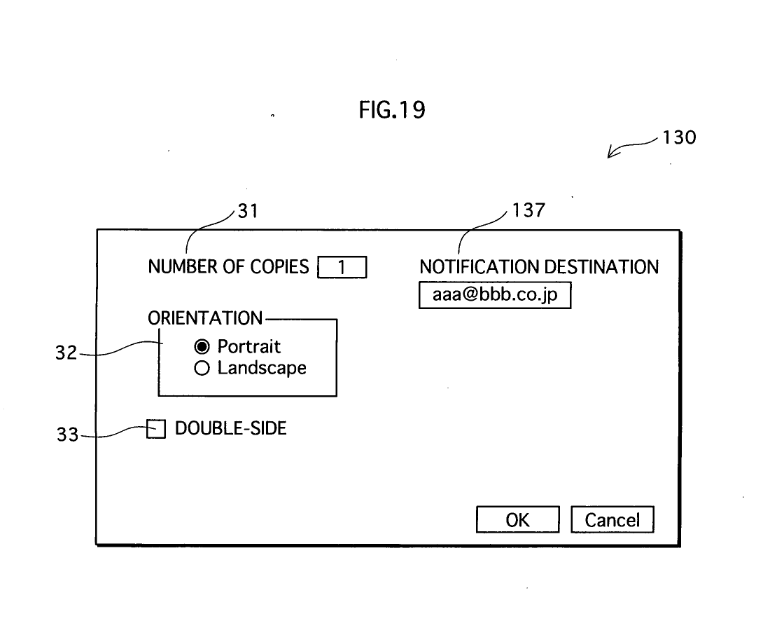

FIG. 19 a diagram showing a screen of a display in the activation of the display unit, relating to a second embodiment;

Just as in the first embodiment, the display unit in the second embodiment displays a prompt screen 130 for prompting a user to input printing information. As shown in FIG. 19, the prompt screen 130 contains such fields as: “number of copies” field 31; “orientation” field 32; “double-side” field 33; and “notification destination” field 137 for receiving an input of a destination if a user desires reception of a completion notification. Just as in the first embodiment, a mail address of a client terminal (e.g. aaa@bbb.co.jp) is inputted in the notification destination field 137. Note that by inputting a mail address, a user indicates his intention of receiving a completion notification, which means that the notification destination field 137 of the second embodiment has the same function as the job completion notification sub-field 35 of the first embodiment.

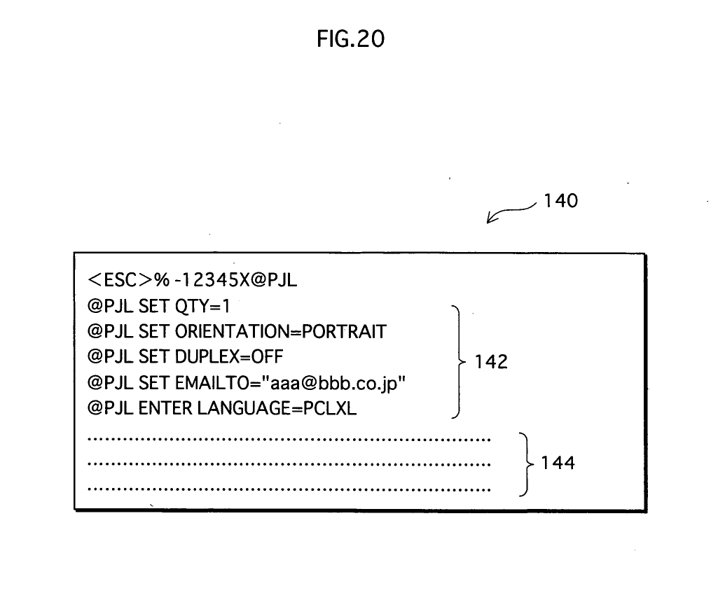

FIG. 20 is a diagram showing a part of printing data to be transmitted to the MFP.

As shown in FIG. 20, printing data 140 contains a substance portion 144 and a header portion 142. The substance portion 144 stores data for image forming. The header portion 142 stores printing information (just as in the first embodiment), and a notification destination (i.e. “@PJL SET EMAILTO=aaa@bbb.com.jp”) following the printing information.

2. MFP

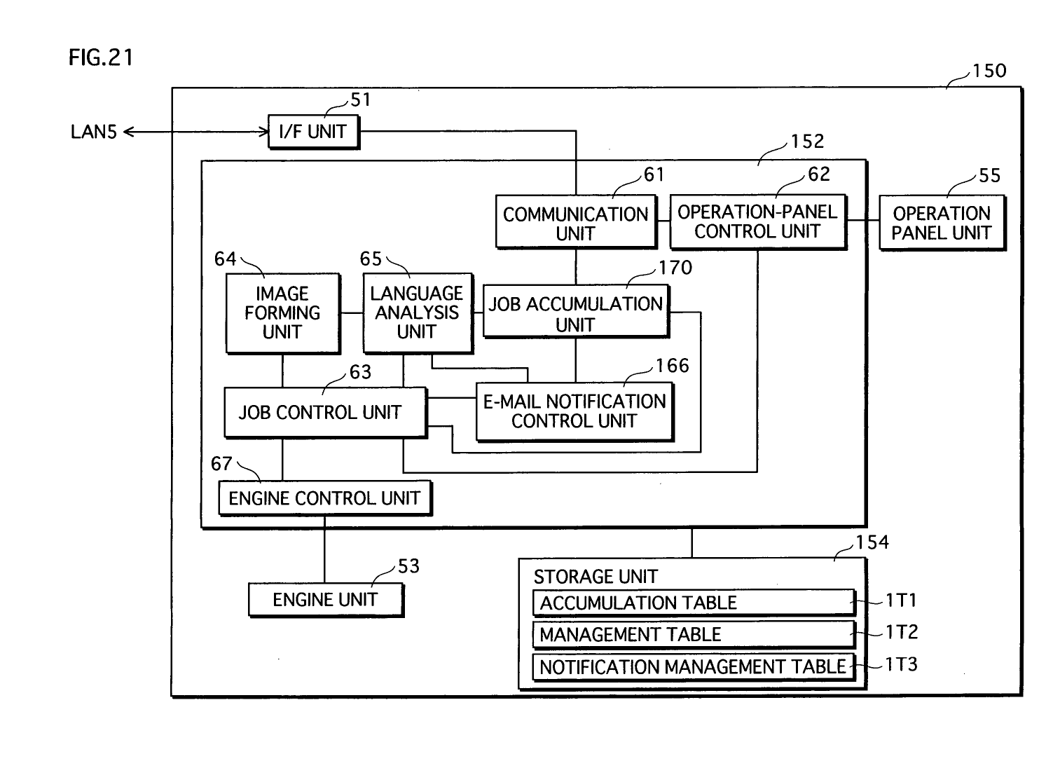

FIG. 21 is a block diagram showing a structure of the MFP.

As shown in FIG. 21, the MFP 150 is comprised of: an interface (I/F) unit 51; a main control unit 152; an engine unit 53; a storage unit 154; an operation panel unit 55, and the like.

Here, the I/F unit 51, the engine unit 53, and the operation panel unit 55 are the same in structure as their counterparts in the MFP of the first embodiment, and so are assigned same reference numbers.

(1) Storage Unit

As shown in FIG. 21, the storage unit 154 stores an accumulation table 1T1, a management table 1T2, and a notification management table 1T3.

The accumulation table 1T1 is for, when a print job is received by the MFP from a client terminal, temporarily storing and managing the print job.

Note that when a print job is received during execution of another print job by the engine unit 53, the received print job is accumulated as it is. Conversely, when a print job is received while no print job is being executed by the engine unit 53, the received print job is immediately transferred to the language analysis unit 65, This accumulation table 1T1 is managed by a job accumulation unit 170 detailed later.

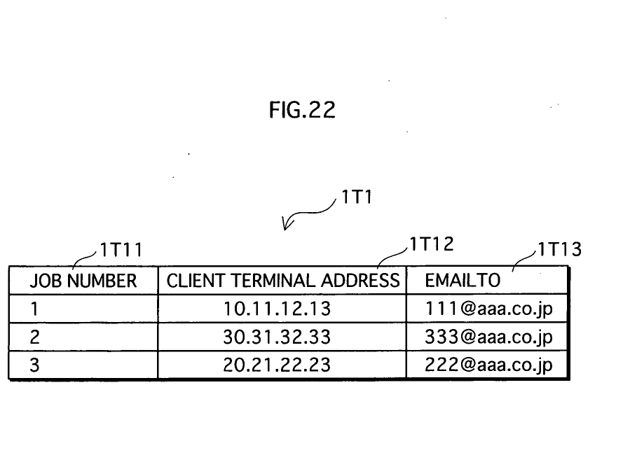

FIG. 22 shows the accumulation table 1T1.

As shown in this drawing, the accumulation table 1T1 has three columns: “job number” column 1T11; “client terminal address” column 1T12; and “EMAILTO” column 1T13. The EMAILTO column 1T13 is for storing information having been stored in the header portion 142 of the printing data 140.

The management table 1T2 is for entering information relating to print jobs received by the MFP from a client terminal. The management table 1T2 is managed by the job control unit 63.

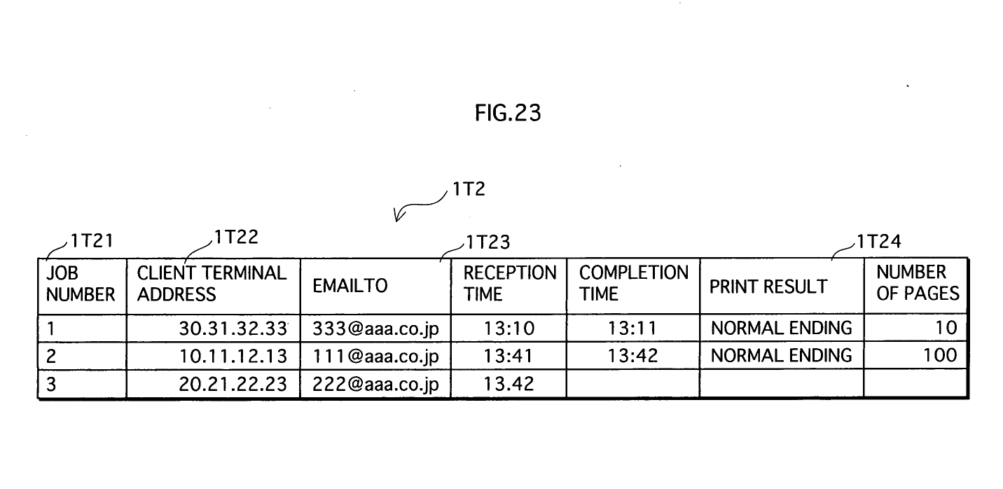

FIG. 23 shows the management table 1T2.

As shown in this drawing, the management table 1T2 has the following columns: “job number” column 1T21; “client terminal address” column 1T22; “EMAILTO” column 1T23; “print result” column 1T24. Besides, a reception time of a print job, a completion time of printing, and a number of pages of printing, and the like, are entered in the management table 1T2.

The notification management table 1T3 is used in, when a print job received by the MFP from a client terminal completes, creating a corresponding notification to the client terminal. The notification management table 1T3 is managed by the e-mail notification control unit 166.

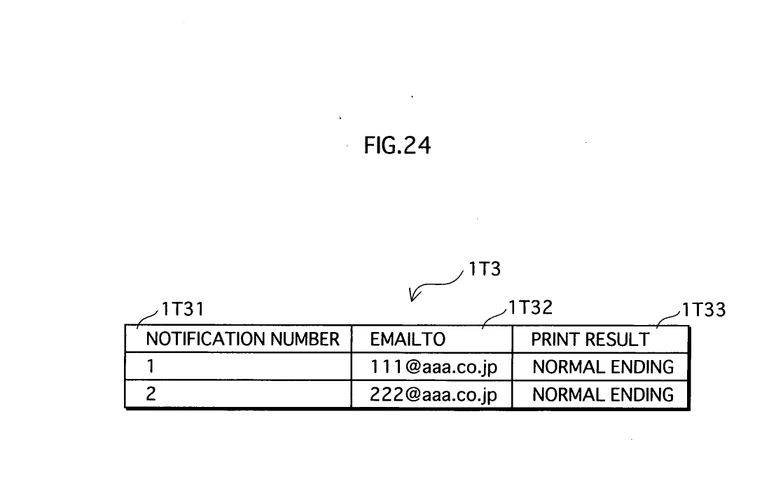

FIG. 24 shows the notification management table 1T3.

As shown in this drawing, the notification management table 1T3 has three columns: “notification number” column 1T31; “EMAILTO” column 1T32; and “print result” column 1T33.

Whenever the e-mail notification control unit 166 transmits a completion notification, information regarding the print job in this notification management table 1T3 is cleared, and the numbering sequence of any row that follows recedes by one row.

(2) Main Control Unit

As shown in FIG. 21, the main control unit 152 includes: a communication unit 61; an operation-panel control unit 62, a job control unit 63, an image forming unit 64, a language analysis unit 65, an e-mail notification control unit 166, and an engine control unit 67, just as in the first embodiment. In addition, the main control unit 152 is newly equipped with a job accumulation unit 170.

Here, the communication unit 61, the operation-panel control unit 62, the job control unit 63, the image forming unit 64, the language analysis unit 65, and the engine control unit 67 are the same in structure and function as their counterparts in the first embodiment.

The job accumulation unit 170 temporarily stores a print job received from the communication unit 61 in the storage unit 154, and transfers the print job to the language analysis unit 65 according to the operational state of the engine unit 53 described above. The operational state of the engine unit 53 is determined based on the information from the job control unit 63. Note that the processing performed by the job accumulation unit 170 is detailed later.

If, after completion of a print job executed in the engine unit 53, the job accumulation unit 170 happens to store a print job whose completion notification is destined for the same destination as the destination of the completion notification of the print job just completed, then the e-mail notification control unit 166 waits till the completion of the print job found in the job accumulation unit 170, and then creates a collective completion notification for these print jobs, and transfers the created collective completion notification to the communication unit 61. Note that the processing performed by the e-mail notification control unit 166 is detailed later. A. Job accumulation unit

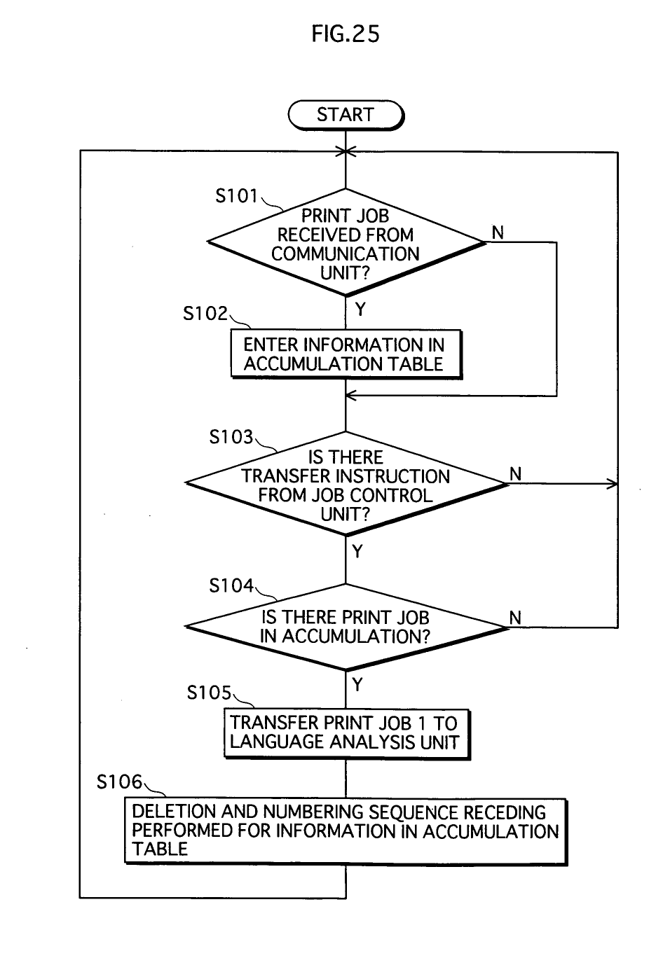

FIG. 25 is a flowchart showing processing performed by the job accumulation unit.

As shown in FIG. 25, the job accumulation unit 170 judges whether a print job is received from the communication unit 61 (Step S101). When the judgment is in the affirmative (Step S101:Y), from the header portion of the printing data of the received print job, predetermined information is extracted and is stored in the client terminal address column 1T12 in the accumulation table 1T1 of FIG. 22 (Step S102). Here, the predetermined information is the IP address of a client terminal having instructed the print job (e.g. “10.11.12.13”). Also in Step S102, the EMAILTO name (e.g. 111@aaa.co.jp) indicating the destination of the completion notification is stored in the EMAILTO column 1T13 of the same accumulation table 1T1, then the control proceeds to Step S103. When the judgment in Step S101 is in the negative (Step S101:N), the control proceeds to Step S103.

In Step S103, it is judged whether a transfer instruction is received from the job control unit 63. This transfer instruction is issued from the job control unit 63 to the job accumulation unit 170 when there is (or will soon be) a lack in a print job to be processed, and is specifically for instructing the job accumulation unit 170 to transfer, to the language analysis unit 65, a print job to be executed next.

If the judgment of Step S103 is in the affirmative (Step S103:Y), it is then judged whether any print job is stored in the job accumulation unit 170 (Step S104). If the judgment in Step S104 is in the affirmative (Step S104:Y), the print job corresponding to the job number “1” in the accumulation table 1T1 is transferred to the language analysis unit 65 (Step S105).

Then the information regarding the job number 1 in the accumulation table 1T1, corresponding to information regarding the print job transferred to the language analysis unit 65, is deleted, the numbering sequence of any row that follows recedes by one row (Step S106), and the control proceeds to Step S101.

Note that if the judgment of Step S103 is in the negative (Step S103:N), the control proceeds to Step S101, and if it is judged that there is no print job in accumulation (Step S104:N), the control also proceeds to Step S101. B. E-mail notification control unit

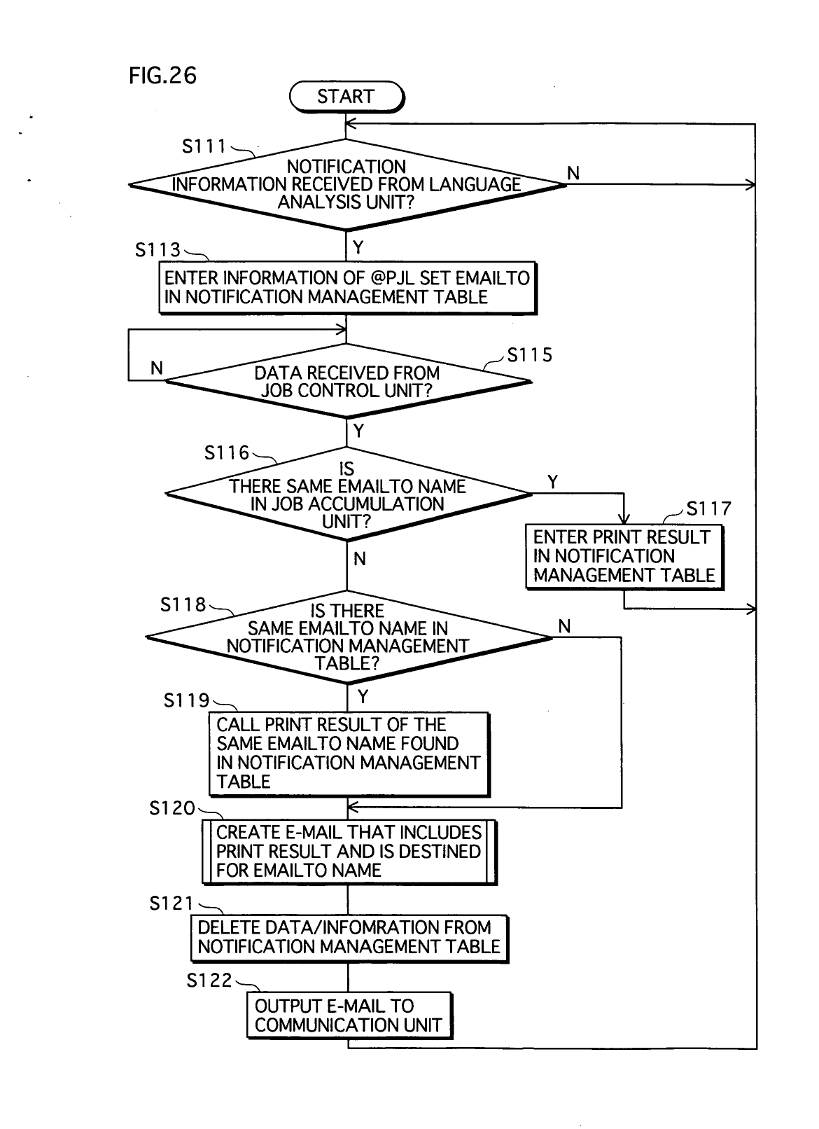

FIG. 26 is a flowchart showing processing performed by the e-mail notification control unit.

As shown in FIG. 26, the e-mail notification control unit 166 judges whether data (notification information) is received from the language analysis unit 65 (Step S111). Note that the notification information is the same as that in the first embodiment.

When the judgment of Step S111 is in the affirmative (Step S111:Y), information of “@PJL SET EMAILTO”, being the completion notification destination (e.g. 111@aaa.co.jp), is entered in the EMAILTO column 1T32 of the notification management table 1T3 shown in FIG. 24 (Step S113). Note that the judgment in the Step S111 is in the negative (Step S111:N), the control returns to Step S111.

Next, in Step S115, it is judged whether data indicating completion of a print job is received from the job control unit 63. The data indicating completion of a print job (print result) is the same as in the first embodiment.

When the judgment in Step S115 is in the affirmative (Step S115:Y), it is then judged whether the job accumulation unit 170 stores any print job having the same EMAILTO name as the EMAILTO name entered in the notification management table 1T3 (Step S116). Specifically, the EMAILTO column 1T13 of the accumulation table 1T1 is checked for the existence of the same EMAILTO name as entered in the notification management table 1T3.

When the judgment is in the affirmative in Step S116 (Step S116:Y), the print result (e.g. “normal ending”) received from the job control unit 63 is entered in the print result column 1T33 in the notification management table 1T3 (Step S117), then the control returns to Step S111.

Conversely, when the judgment is in the negative in Step S116 (Step S116:N), it is then judged whether the same EMAILTO name as the EMAILTO name of the print job corresponding to the print result received from the job control unit 63 exists in the EMAILTO column 1T32 of the notification management table 1T3 (Step S118).

If the judgment is in the affirmative in Step S118 (Step S118:Y), the print result corresponding to the EMAILTO name is called (Step S119), and e-mail including the print result and is destined for the EMAILTO name is created (Step S120). Then after all data/information regarding the created e-mail is deleted (Step S121), the created e-mail is outputted to the communication unit 61 (Step S122).

On the other hand, if the judgment is in the negative in Step S118 (Step S118:N), e-mail including the print result and is destined for the EMAILTO name is created (Step S120). Then after all data/information regarding the created e-mail is deleted (Step S121), the created e-mail is outputted to the communication unit 61 (Step S122). Finally, after completion of Step S122, the control returns to Step S111.

(3) Concrete Example

A concrete example of the e-mail notification control unit 166 is described as follows.

First, as shown in FIG. 22, three print jobs are accumulated in the accumulation table 1T12. In addition, the notification management table 1T33 stores one print job having already complete but a corresponding notification thereof has not been transmitted yet. Note that in FIG. 24, there are two print jobs, and only the first print job is assumed to have been complete.

Under these conditions, the job number “3” is currently under execution. Accordingly, in the management table of FIG. 23, the bottom row corresponding to the job number 3 is half complete up to the reception time column.

When data indicating completion of this print job currently under execution is received in Step S115, the judgment of Step S116 is performed, which results in the affirmative since the accumulation table 1T1 managed by the job accumulation unit 170 contains a print job having the same EMAILTO name of this print job (222@aaa.co.jp) (i.e. job number “3”). Accordingly, the print result (normal ending) received from the job control unit 63 is entered in the notification management table 1T3, in the print result column 1T33 corresponding to the notification number “2”. According to this operation, the state as shown in FIG. 24 is generated. Then the control proceeds to Step S111.

A completion notification with regard to the EMAILTO name of 222@aaa.co.jp is created and transmitted after the print job in the accumulation table 1T1 completes.

After the above-described operation, the engine unit 53 executes a print job for the job number 1 (hereinafter simply “print job 1”), which is entered in the top row of the accumulation table 1T1 of FIG. 22. In execution of the print job “1”, the data of the print job 1 is transferred to the language analysis unit 65, and so the top row of the accumulation table 1T1 in FIG. 22, which corresponds to the print job 1, is deleted. Accordingly, the numbering sequence of the job number 2 in FIG. 22 recedes by one row, to be a new job number 1. Likewise, the numbering sequence of the job number 3 in FIG. 22 recedes by one row, to be a new job number 2.

The e-mail notification control unit 166 receives data indicating completion of a print job whose notification information is received from the language analysis unit 65 (i.e. a print job currently under execution by the engine unit 53) in Step S115. Then the e-mail notification control unit 166 judges in the negative in Step S116, since the accumulation table 1T1 does not contain any print job having the same EMAILTO name of this print job (i.e. 111@aaa.co.jp, see “print job number 1” in the accumulation table 1T1 in FIG. 22). The control then proceeds to Step S118.

The judgment of Step S118 results in the affirmative, because the EMAILTO column 1T32 of the notification management table 1T3 of FIG. 24 contains 111@aaa.co.jp. Consequently in Step S119, the print result entered in the print result column 1T33 corresponding to the EMAILTO name of 111@aaa.co.jp is called, thereby creating e-mail that includes the print result of the print job just executed and is destined for 111@aaa.co.jp. Then all the information regarding the print job is deleted from the notification management table 1T3 (Steps S119, S120, S121, and S122), and the control proceeds to Step S111.

3. Summary

As described above, if, for example upon completion of a print job, the job accumulation unit contains any print job(s) having the same completion notification destination as that of the completed print job, the present embodiment is designed to perform one collective completion notification for these print jobs having the same completion notification destination after completion of the print job(s) found in the accumulation unit.

According to this structure, when the client terminal has issued a plurality of sequential print instructions, it will not receive a completion notification each time one print job completes. Therefore, the user is relieved of the annoyance of receiving the same number of job completion notifications as the number of the requested print jobs. Furthermore, the number of completion notifications to be transmitted on the network is lessened, which contributes to reduction of network traffic load.

4. Modification Example

(1) Third Modification Example

In the above-described second embodiment, if there is any print job(s) having the same completion notification destination as that of a just completed print job, the MFP issues a collective completion notification for these print jobs having the same completion notification destination, regardless of the print results of these print jobs.

It is alternatively possible to associate a timing of notifying a print result of a print job and a timing of transmitting a completion notification. The following describes a third modification example designed to transmit a completion notification when the print result of a print job indicates “abnormal ending”. This print result can be considered as an error notification.

The present third modification example is designed to transmit a collective completion notification for a print job having ended abnormally and any print jobs having the same EMAILTO name as the abnormally ended print job.

An e-mail notification control unit 166a in the MFP of a third modification example is different from the e-mail notification control unit 166 of the second embodiment because of having a function of: judging whether a print result is a predetermined result (e.g. abnormal ending), and transmitting a completion notification if the judgment is in the affirmative. The other components of the MFP in the third modification example is the same as those in the MFP in the second embodiment.

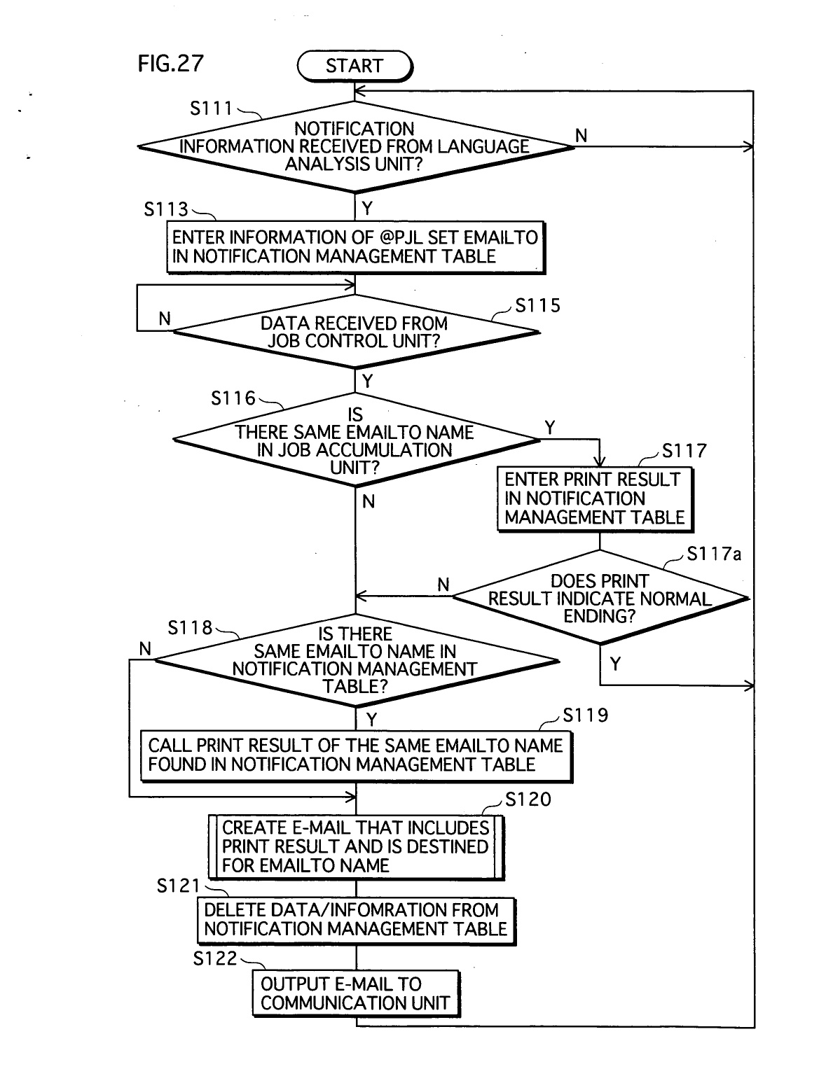

FIG. 27 is a flowchart showing completion notification processing in the third modification example.

The difference of the flowchart regarding the third modification example with the flowchart of FIG. 26 is that insertion of Step S117a between Step S117 and Step S111. In this Step S117a, it is judged whether the print result indicates normal ending or abnormal ending. If the print result indicates normal ending, the control proceeds to Step S111 just as in the second embodiment. If the print result indicates abnormal ending, the control proceeds to Step S118. Note that the processing after Step S118 in FIG. 27 is the same as the processing after Step S118 in FIG. 26.

According to the above-stated flow, the completion notification of the third modification example is to contain at least a print result that indicates abnormal ending. By doing so, the client terminal can deal with such cases as re-issuing of a print instruction to the MFP regarding the abnormally ended print job, and of fixing the mechanical error caused in the MFP (e.g. paper jam).

(2) Fourth Modification Example

In the second embodiment, it is judged whether the job accumulation unit 170 stores (manages) any print job having the same EMAILTO name as the EMAILTO name entered in the notification management table 1T3 (Step S116 of FIG. 26). However, in judging the presence of such print jobs, it is possible to use other information than EMAILTO name. The following describes such a case as the fourth modification example.

In the fourth modification example, printing data transmitted from a client terminal contains information of a group to which the user belongs. Specifically, it is judged whether the job accumulation unit stores the same group information as the group to which the user of the client terminal belongs.

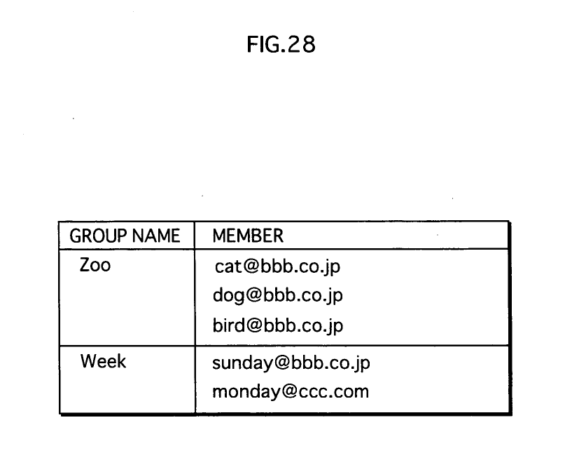

FIG. 28 is a diagram showing how the grouping is performed.

In this diagram relating to the fourth modification example, users are divided into two types of “Zoo” and “Week”. The group of “Zoo” includes members respectively having mail addresses of “cat@bbb.co.jp”, “dog@bbb.co.jp”, and “bird@bbb.co.jp”. Meanwhile, the group of “Week” includes members respectively having mail addresses of “sunday@bbb.co.jp” and “Monday@bbb.co.jp”.

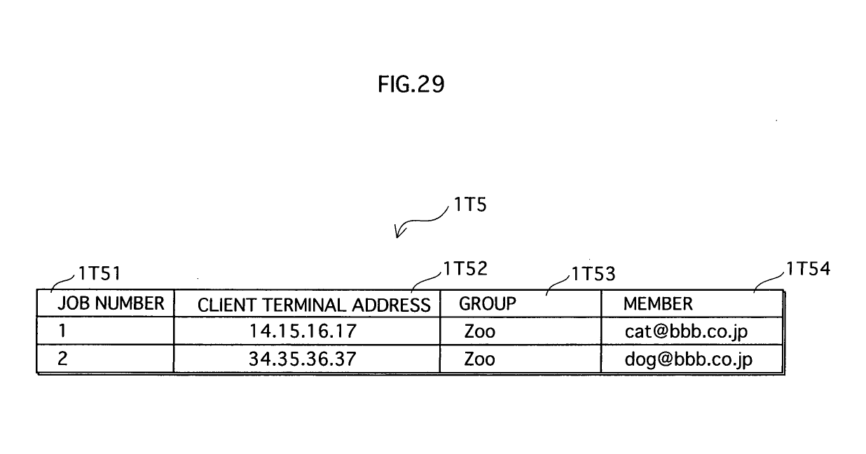

FIG. 29 is a diagram showing an accumulation table relating to the fourth modification example.

As shown in this drawing, the accumulation table 1T5 has four columns: “job number” column 1T51; “client terminal address” column 1T52; “group” column 1T53; and “member” column 1T54. The group column 1T53 is newly added, and corresponds to information stored in the header portion of printing data.

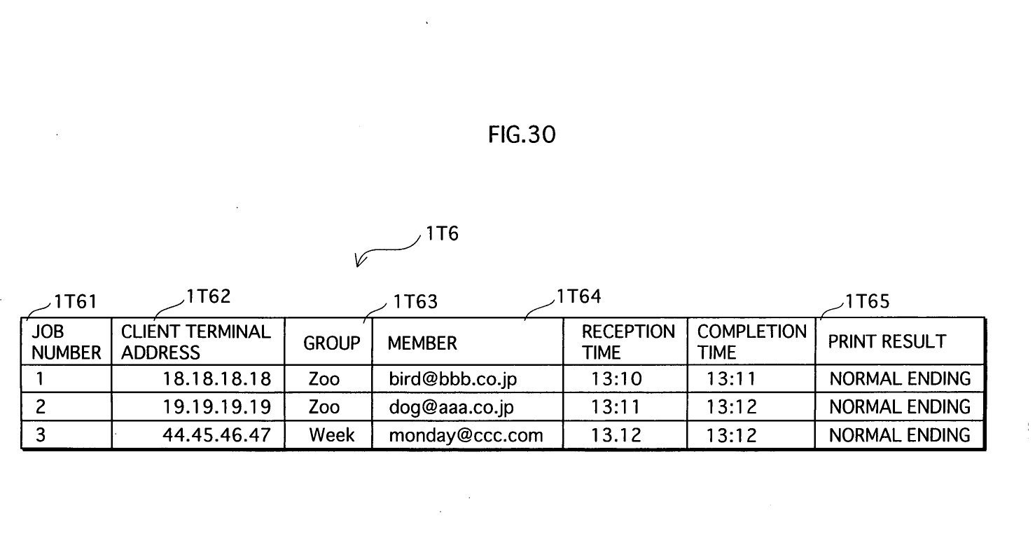

FIG. 30 is a diagram showing a management table 1T6 relating to the fourth modification example.

As shown in this drawing, the management table 1T6 has such columns as: “job number” column 1T61; “client terminal address” column 1T62; “group” column 1T63; “member” column 1T64; and “print result” column 1T65.

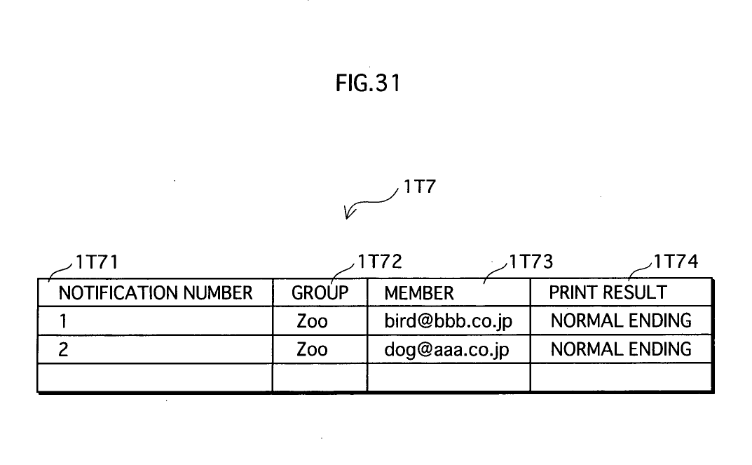

FIG. 31 is a diagram showing a notification management table relating to the fourth modification example.

As shown in this drawing, the notification management table 1T7 has four columns: “notification number” column 1T71; “group” column 1T72; “member” column 1T73; and “print result” column 1T74. Note that every time the e-mail notification control unit transmits a completion notification, the corresponding information or the like is deleted from this notification management table 1T7, and accordingly the numbering sequence of any row that follows recedes by one row.

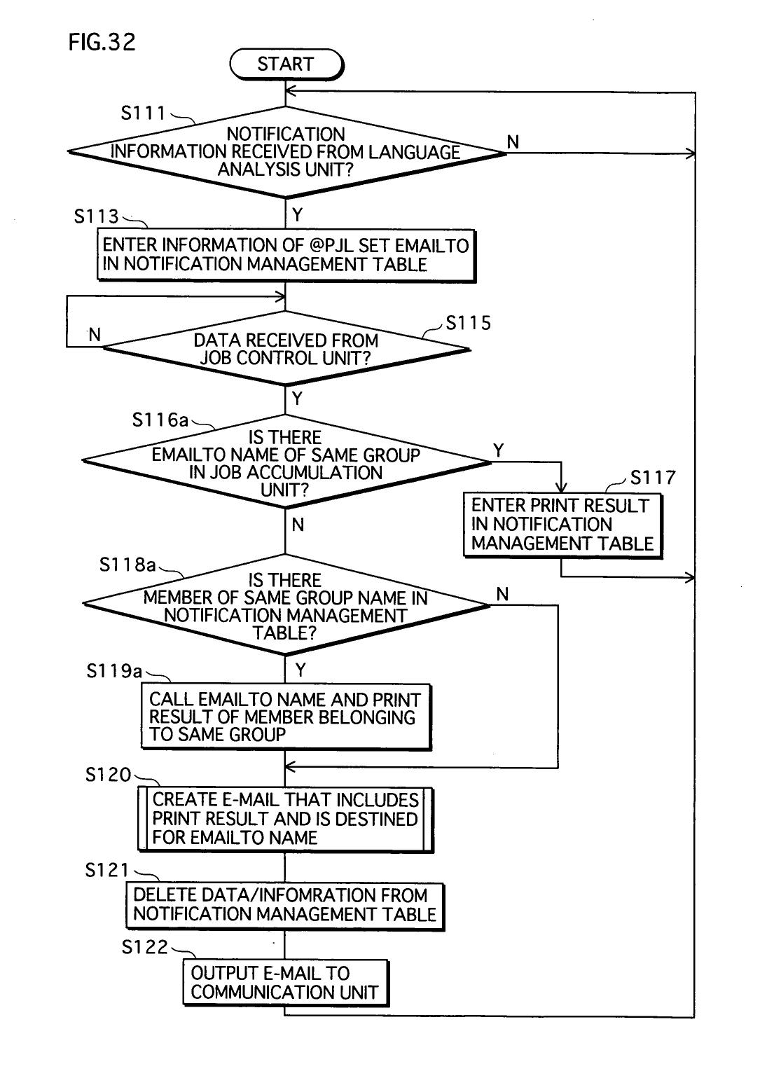

FIG. 32 is a flowchart showing processing performed by the e-mail notification control unit relating to the fourth modification example.

The difference of the processing performed by the present e-mail notification control unit with the operation performed in the second embodiment (see FIG. 26) lies in Steps S116, S118, and S119. Other steps in FIG. 32 are the same as their counterparts in FIG. 26. In view of this, FIG. 32 illustrates steps different from FIG. 26 by assigning “a” after the corresponding step numbers, as Steps S116a, S118a, and S119a. The following mainly describes Steps S116a, S118a, and S119a.

As shown in FIG. 32, the e-mail notification control unit in the fourth modification example, upon reception of data indicating completion of a print job from the job control unit in Step S115, judges whether the accumulation table 1T5 stores the same group as the group to which the EMAILTO name of the completed print job belongs (Step S116a).

When the judgment is in the affirmative in Step S116a (Step S116a:Y), the print result received from the job control unit is entered in the print result column 1T74 in the notification management table 1T7 (Step S117), and the control proceeds to Step S111.

Conversely, when the judgment is in the negative in Step S116a (Step S116a:N), it is then judged whether the notification management table 1T7 stores any member name belonging to the same group (Step S118a).

If the judgment of Step S118a results in the affirmative, the EMAILTO name and the print result of this member are called (Step S119), then the control proceeds to Step S120. Conversely if the judgment of Step S118a results in the negative, the control directly proceeds to Step S120. Note that as a result of the processing after Step S120, a completion notification corresponding to these completed print jobs is created and transmitted.

Note that in Step S120, it is also possible to transmit the completion notification to all the members belonging to the same group. If this structure is adopted, it is advantageous in that completion notifications are issued to all the members of the group, i.e. in the unit of group.

### Third Embodiment

In the first embodiment, one collective completion notification for so-far completed print jobs is transmitted to a client terminal, in accordance with the instruction from the client terminal. In the second embodiment, a collective completion notification for so-far completed print jobs is transmitted to a client terminal, according to an operational state of print jobs received by the MFP from the client terminal.

In contrast, in the present third embodiment, it is judged whether one completion notification should be transmitted for one print job, or one collective completion notification should be transmitted for a plurality of print jobs, using the completion notification destination included in a print job received from a client terminal.

1. Structure

In the third embodiment, the client terminal is the same in structure as the client terminal of the second embodiment. In addition, the information stored in the header portion of printing data that the client terminal issues directed to the MFP is the same as in the second embodiment.

On the other hand, the MFP is almost the same in structure as the MFP of the first embodiment. However, the MFP of the third embodiment is different from the MFP of the first embodiment in the processing performed by the e-mail notification control unit and in the contents of the notification management table. Moreover, the storage unit of the third embodiment newly stores therein a destination management table for the purpose of managing completion notification destinations, which constitutes a difference with the first embodiment.

As mentioned above, the e-mail notification control unit in the third embodiment is designed to judge whether one completion notification should be transmitted for one print job, or one collective completion notification should be transmitted for a plurality of print jobs, using a completion notification destination.

Specifically, a transmission timing of a completion notification is judged using information on a completion notification destination (i.e. domain name of a mail address), where the information (i.e. domain name) is managed in the destination management table.

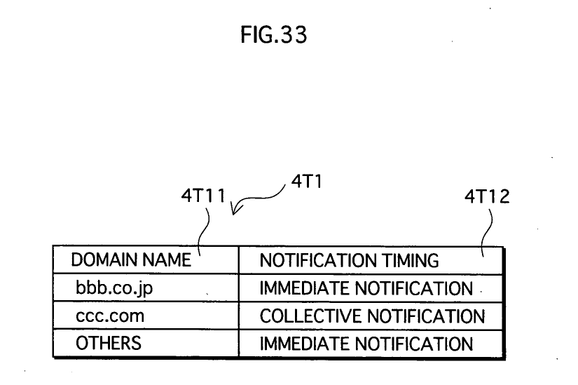

FIG. 33 is a diagram showing the destination management table.

As shown in this drawing, the destination management table 4T1 has two columns: “domain name” column 4T11; and “notification timing” column 4T12. The domain name and the notification timing are entered in advance by a system manager or a user of a client terminal or the like. Such information may be entered by the manager or the user directly to the MFP via a network, and may also be performed via the operation panel unit of the MFP (see FIG. 6).

In the third embodiment, when the domain name of the mail address, being a completion notification destination, is “bbb.co.jp”, the completion notification is immediately transmitted (“immediate notification” in the drawing), and when the domain name is “ccc.com”, the completion notification is transmitted as part of a collective completion notification (“collective notification” in the drawing). If the domain name of a completion notification destination of a requested print job does not match any of the domain names stated above, (i.e. other cases), the completion notification is immediately transmitted (“immediate notification”).

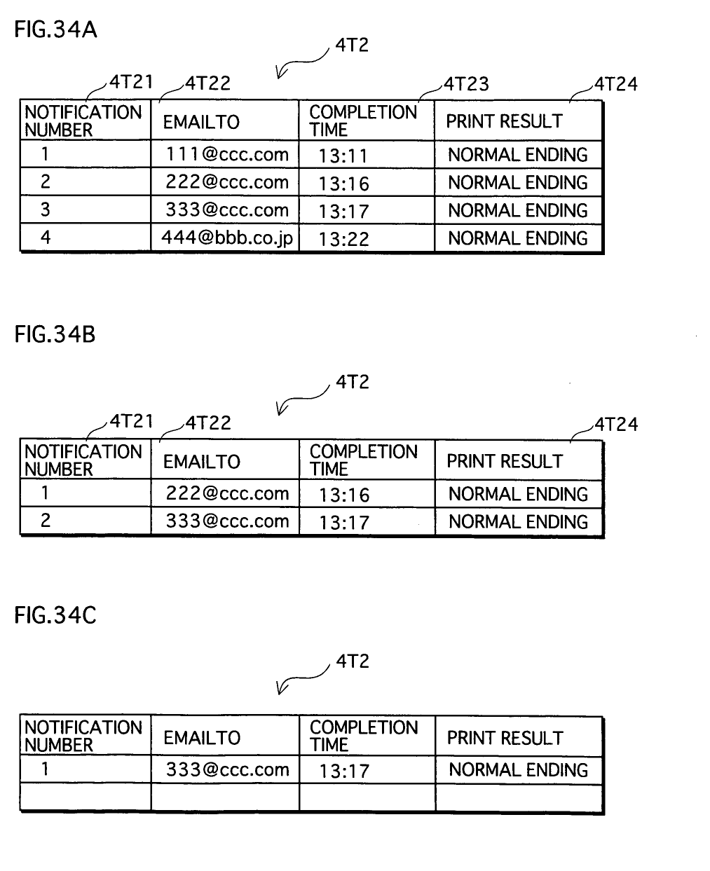

FIGS. 34A, 34B, and 34C respectively show a notification management table of the third embodiment. Note that these table indicate different scenes of the same notification management table 4T2, therefore has different contents from each other.

As these drawings show, the notification management table 4T2 has four columns: “notification number” column 4T21; “EMAILTO” column 4T22; “completion time” column 4T23; and “print result” column 4T24. When information indicating completion of a print job is received form the job control unit, information relating to the completed print job (e.g. completion time, print result) is entered in this job management table 4T2.

2. Processing

As follows, concrete processing performed by the e-mail notification control unit is described.

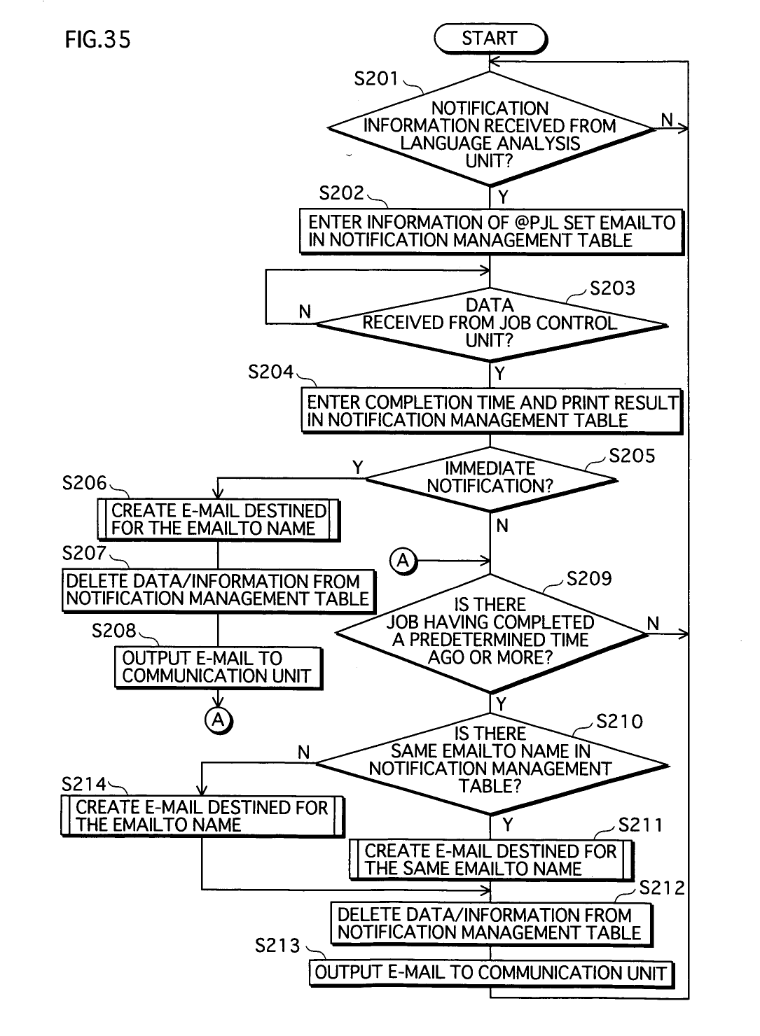

FIG. 35 is a flowchart showing processing performed by the e-mail notification control unit.

As shown in FIG. 35, the e-mail notification control unit judges whether data (notification information) is received from the language analysis unit (Step S201). Note that the notification information is the same as in the first embodiment.

When the judgment is in the affirmative (Step S201:Y), in Step S202, information of “@PJL SET EMAILTO”, being the completion notification destination such as 111@ccc.co.jp, is entered in the EMAILTO column 4T22 of the notification management table 4T2 (see FIG. 34). Note that when the judgment is in the negative (Step S201:N), the control returns to Step S201.

Next, in Step S203, it is judged whether data indicating completion of a print job is received from the job control unit. The data indicating the completion corresponds to “print result”, just as in the first embodiment.

In Step S203, when data indicating completion (print result) is judged to be received, the completion time of the print job is entered in the completion time column 4T23 of the notification management table 4T2 (e.g. “13:11”), and the print result of the print job is entered in the print result column 4T24 (e.g. “normal ending”) (Step S204).

Next in Step S205, it is judged, from the notification destination of the print job whose data has been received in Step S203, whether the completion notification for the received print job should be considered “immediate notification”. Specifically, this judgment is performed by comparing the domain name of the mail address entered (Step S202) in the EMAILTO column 4T22 of the notification management table 4T2 and the domain names entered in advance in the destination management table 4T1.

Next, when the judgment of Step S205 is in the affirmative (Step S205:Y), then the control proceeds to Step S206 and e-mail for the print job is created. Then after data relating to the print job is deleted from the notification management table 4T2, the e-mail is outputted to the communication unit (Steps S207 and S208). The control then proceeds to Step S209.

When the judgment of Step S205 is in the negative (Step S205:N), the control proceeds to Step S209 where it is judged whether there is a print job having completed for a predetermined time or more, by checking the information in the completion time column 4T23 of the notification management table 4T2.

When the judgment of Step S209 is in the affirmative (Step S209:Y), then it is checked whether the same EMAILTO name exists in the EMAILTO column 4T22 of the notification management table 4T2 (Step S210).

When the judgment of Step S210 is in the affirmative (Step S210:Y), e-mail including the print result or the like relating to these print jobs is created, and the data and the like used in the mail creation is deleted from the notification management table 4T2, and the e-mail is outputted to the communication unit (Steps S211, S212, and S213), and the control proceeds to Step S201.

On the other hand, when the judgment of Step S210 is in the negative (Step S210:N), e-mail including only the print result relating to this print job is created, and data and the like used in the mail creation is deleted from the notification management table 4T2, and the e-mail is outputted to the communication unit (Steps S214, S212, and S213), and the control proceeds to Step S201.

Note that the judgment of Step S209 is in the negative (Step S209:N), the control returns to Step S210.

3. Embodiment Example

The following describes processing of transmitting a completion notification for a completed print job to the client terminal, with use of an embodiment example.

This embodiment example assumes a case where the destination management table 4T1 stores two domain names of “bbb.co.jp” and “ccc.com” (FIG. 33), the notification management table 4T2 indicates that the print jobs up to the notification number 3 have been completed (FIG. 34A), and execution of the print job corresponding to the notification number 4 is about to start (FIG. 34A). Such a case is described in detail with use of the flowchart of FIG. 35.

Note that in this modification example, a predetermined time in Step S209 of FIG. 35 is assumed to be “10 minutes”, and the judgment time is “13:22”.

The e-mail notification control unit first receives data from the language analysis unit in Step S201, and enters “444@bbb.co.jp” in the EMAILTO column 4T22 corresponding to the notification number “4” (bottom row) of the notification management table 4T2 (Step S202).

Then when data indicating completion of the job is received from the job control unit (Step S203), the completion time (13:22) and the print result (normal ending) of the completed print job are respectively entered in the completion time column 4T23 and the print result column 4T24 in the notification management table 4T2, in the row corresponding to the notification number 4 (Step S204). After this processing, the notification management table 4T2 will be in the state as illustrated in FIG. 34A.

Here the domain name of the 444@bbb.co.jp is judged to match the domain name “bbb.co.jp” in the domain name column 4T11 of the destination management table 4T1, and so this case is judged as “immediate notification” in Step S205 (Step S205:Y), and the control proceeds to Step S206.

Then e-mail is created for performing a completion notification regarding this print job. After data/information used in creating the completion notification is deleted from the notification management table 4T2, the created e-mail is outputted to the communication unit (Steps S206, S207, and S208), and then the control proceeds to Step S209.

Here, the current time is “13:22”, and the completion time of the notification number 1 is “13:11” in the notification management table 4T2, and so in Step S209, it is judged that the print job has been completed more than a predetermined time (more than 10 minutes), and so the control proceeds to Step S210. In Step S210, it is judged whether the same EMAILTO name as the EMAILTO name of the print job exists in the notification management table 4T2.

Here, the notification management table 4T2 does not store any item having the EMAILTO name of “111@ccc.com”, and so the control proceeds to Step S214, where e-amil destined for this EMAILTOname is created. Then data and the like entered in the row corresponding to the notification number 1 is deleted, and the e-mail is outputted to the transmission unit (Steps S212, S213), and the control proceeds to Step S201.

Note that as a result of the above processing, data corresponding to the notification numbers 1 and 4 (FIG. 34A) is deleted, and the numbering sequence of the following two rows recedes by one row respectively, to become new notification numbers 1 and 2.

Next, assume that a print job having the same EMAILTO name (completion notification destination) as the EMAILTO name of the notification number 1 in the notification management table 4T2 after update is received from the language analysis unit. Then after completion of the job, the completion time and the print result are entered in the row of the notification number 3 in the notification management table 4T2 (not illustrated in the drawing). Then in Step S205, it is judged whether the completed print job corresponds to a case of “immediate notification”.

Since the EMAILTO name of this print job is “222@ccc.com”, Step S205 results in the negative (Step S205:N), and so the control proceeds to Step S209. Since the current time is 13:27, the print job of the notification number 1 has been completed for more than 10 minutes, the judgment of Step S209 results in the affirmative (Stpe S209:Y). Therefore the control proceeds to Step S210 where it is judged whether the same EMAILTO name as the EMAILTO name of the print job of the notification number 1 exists in the notification management table 4T2.

In the notification management table 4T2, the notification number 3 has the same EMAILTO name (i.e. 222@ccc.com), and so the control proceeds to Step S211 and e-mail (i.e. collective completion notification) is created for the same EMAILTO name, and data and the like entered in the rows of the notification numbers 1 and 3 is deleted. Then the e-mail is outputted to the transmission unit (so far, Steps S212 and S213). After this, the control proceeds to Step S201.

As a result of the above processing as well as the following numbering sequence receding, the notification management table 4T2 will only have the data corresponding to the number 1.

4. Summary

As explained above, the third embodiment either creates a completion notification indicating completion of one print job, or a collective completion notification indicating completion of a plurality of print jobs, in accordance with the completion notification destination.

As a result, the completion notification destination enables to judge whether a plurality of print jobs are received from a client terminal, even if such information reporting such incident is not reported by the client terminal. Accordingly, just as in the first and second embodiments, when the client terminal has issued a plurality of sequential print instructions, it will not receive a completion notification each time one print job completes, and so the user is relieved of the annoyance of receiving the same number of job completion notifications as the number of the requested print jobs. Furthermore, the number of completion notifications to be transmitted on the network is lessened, which contributes to reduction of network traffic load.

5. Modification Example

As follows, modification examples relating to the third embodiment are described.

(1) Fifth Modification Example

In the third embodiment, a collective completion notification was used for completion notification of two print jobs, based on the elapsed time from the job completion. However, there will be a case where completion notification of three or more print jobs is performed as a collective completion notification. Moreover, other conditions than the elapsed time after job completion may be used for determining whether it is a case of collective completion notification.

As follows, one of such cases is described as a fifth modification example. In this fifth modification example, a collective completion notification is performed if it is interpreted that completion notification of a print job in the notification management table requires a collective completion notification.

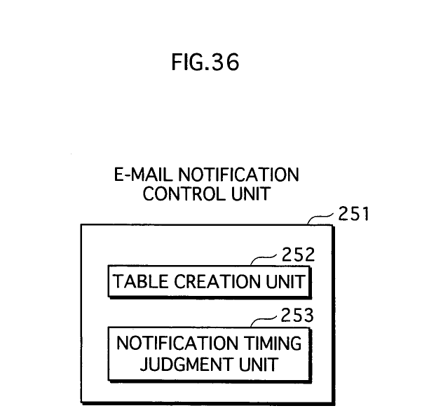

FIG. 36 is a block diagram showing the e-mail notification control unit of the fifth modification example.

As shown in this drawing, the e-mail notification control unit 251 includes a table creation unit 252 and a notification timing judgment unit 253.

The table creation unit 252 enters information relating to a completion notification of a completed print job in the notification management table 4T2 shown in FIG. 34. The notification timing judgment unit 253 transmits a completion notification (not transmitted yet) from the notification management table 4T2 under a predetermined condition. At this timing, if any item having the same EMAILTO name is found in the notification management table 4T2, the completion notification for the found item(s) is also transmitted as part is of a collective completion notification.

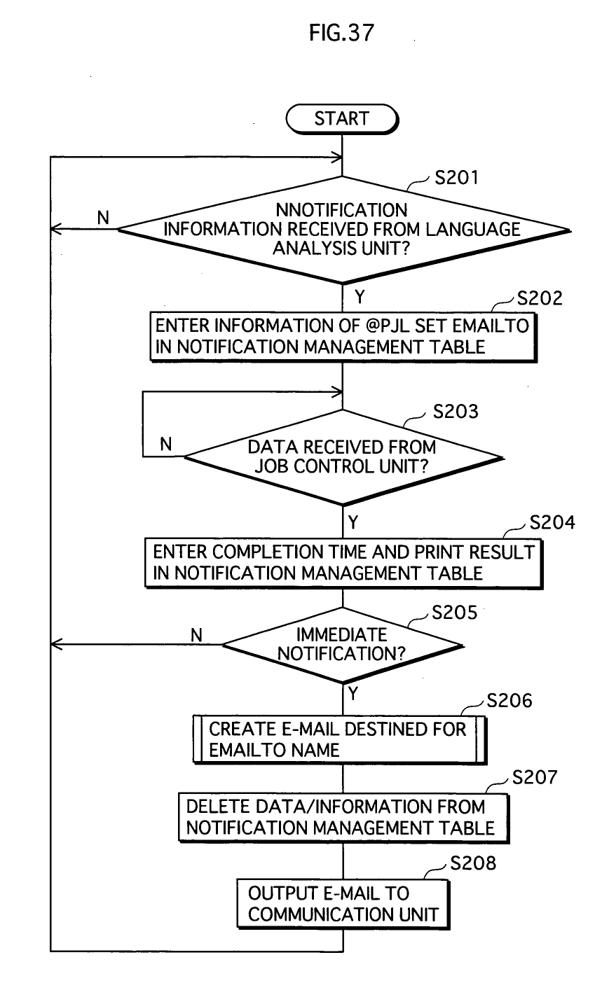

FIG. 37 is a flowchart showing processing performed by the table creation unit 252.

As shown in FIG. 37, the processing of the table creation unit 252 is structured by Steps S201, S202, S203, S204, S205, S206, S207, and S208 of FIG. 35. In other words, the processing of the table creation unit 252 is almost the same as the processing illustrated in FIG. 35, except that the steps performed when it is not judged as a case of “immediate notification” are omitted therefrom. The corresponding steps will be performed by the notification timing judgment unit 253.

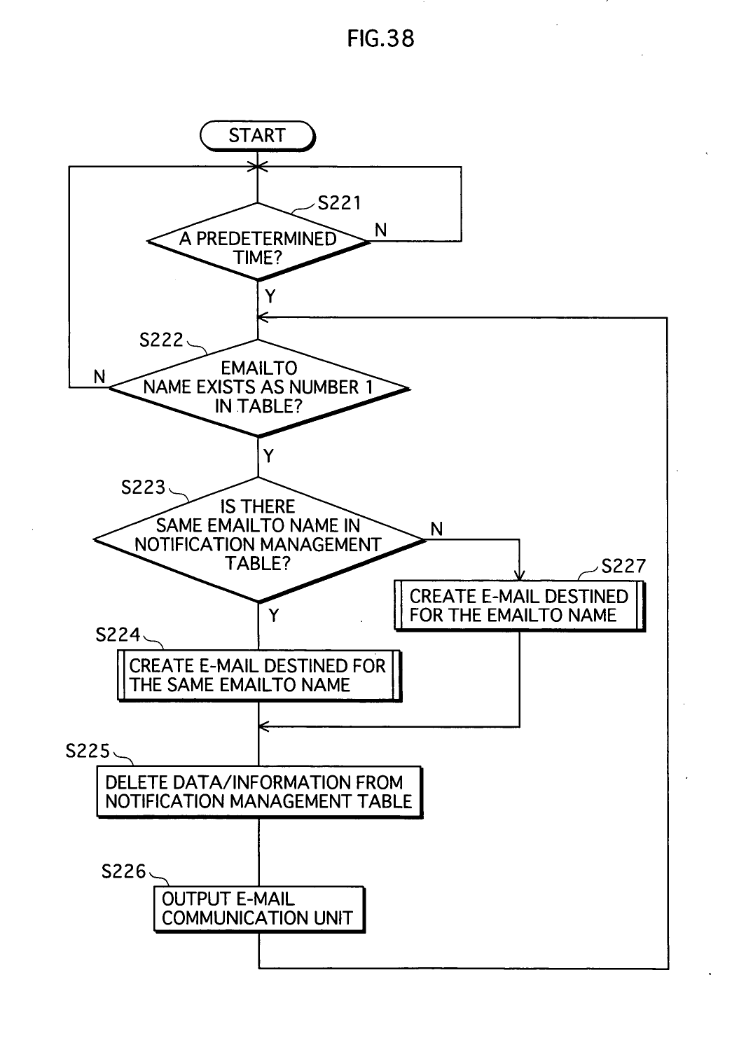

FIG. 38 is a flowchart showing processing performed by the notification timing judgment unit 253.

The notification timing judgment unit 253 in this fifth modification example transmits completion notifications for the items found in the notification management table 4T2 at predetermined times (e.g. 12:00, 12:10, 12:20, 12:30, 12:40, 12:50). When there are more than one item having the same EMAILTO name stored in the notification management table 4T2 at each of the predetermined times, a collective completion notification is used.

In Step S221, it is judged whether the current time is one of the predetermined times. When the judgment of Step S221 is in the affirmative, the control proceeds to Step S222. In Step S222, it is judged whether the notification management table 4T2 has an entry of EMAILTO name as the notification number 1 of the notification management table 4T2. If there is no entry as the notification number 1, this means that there is no print job whose completion notification should be transmitted, and so the control returns to Step S221.

If the judgment of Step S222 results in the affirmative, in Step S223 it is then judged whether the same EMAILTO name as the found EMAILTO name exits in the notification management table 4T2.

If the judgment of Step S223 results in the affirmative, e-mail including all of them is created, and the data and the like used in the creation of the e-mail is deleted from the notification management table 4T2, and the created e-mail is outputted to the e-mail notification control unit (Steps S224, S225, S226), and the control returns to Step S222.

On the other hand, if the judgment of Step S223 results in the negative, e-mail based on the EMAILTO name is created (Step S227), and the control proceeds to Step S225.

As described above, in the fifth modification example, whether a completion notification of a print job should be performed immediately or as part of a collective completion notification is judged based on the completion notification destination of the print job. When the current time reaches one of the predetermined times, a completion notification is created and transmitted (if there are a plurality of corresponding print jobs, the completion notification is “collective completion notification”).

In this structure, information regarding completion of a print job continues to be received and entered in the notification management table 4T2 before the current time reaches one of the predetermined times, the corresponding completion notification is able to be included in a collective completion notification. This is advantageous if one client terminal has transmitted a plurality of print instructions during the time interval.

In the fifth modification example, the notification timing judgment unit 253 creates a completion notification at each predetermined time. In other words, the notification timing judgment unit 253 creates a completion notification at a predetermined time interval (i.e. every 10 minutes in the stated example).

It is also possible to determine the timing of creating a completion notification using other criteria. For example, the criteria may be at the time when the number of entry in the notification number column 4T21 has reached a predetermined number.

(2) Sixth Modification Example and Seventh Modification Example

In the both of the third embodiment and the fifth modification example, the timing of creating a completion notification for any completed print job is determined by referring to the domain name of the destination mail address. However, other information may be used in the determination. As follows, the sixth and seventh modification examples describes such information respectively.

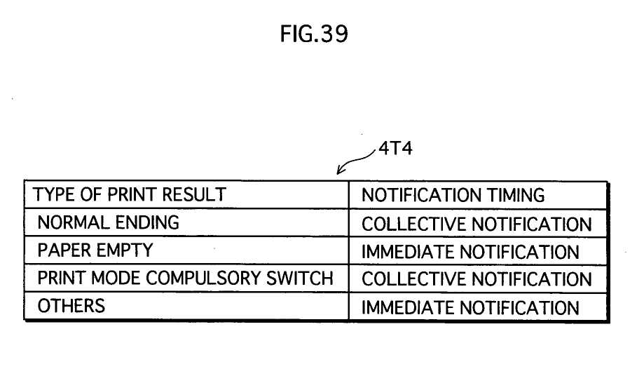

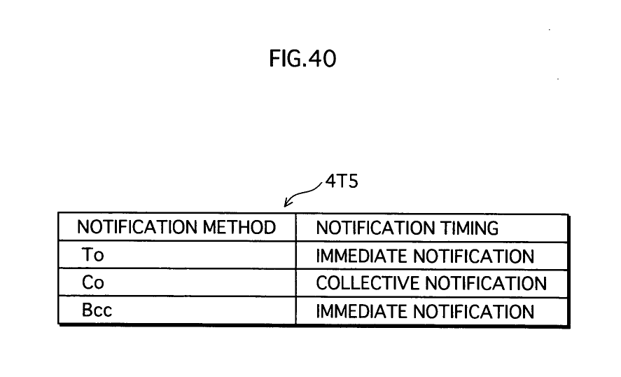

FIG. 39 shows a destination management table relating to the sixth modification example, and FIG. 40 shows a destination management table relating to the seventh modification example.

In the destination management table 4T4 of the sixth modification example (FIG. 39), the notification timing is set according to the type of print result. For example, when the print result indicates normal ending, “collective notification” is specified.

Whereas in the destination management table 4T5 of the seventh modification example (FIG. 40), the notification timing is set according to the notification method.

Specifically in the seventh modification example, the notification timing is set in creation of e-mail to be transmitted to a client terminal, according to the field attribute in the mail header of the e-mail. The field attribute includes “To” that indicates the destination mail address, and “Cc” and “Bcc” that indicate the destination of the copy of the mail.

“Bcc” is used for example when many people require the printout of a print job issued from one client terminal. In this case, if the destination indicated by the “Bcc” is stored in the notification information of the print job and arrangement is made so that the completion notification is also sent to the destination indicated by the “Bcc”. Then a user corresponding to the destination indicated by the “Bcc” can go fetch the printout at the MFP upon reception of the completion notification.

In such a case where the system manager requires the printing state, for example, the corresponding destination may be set as “Cc”, so that the completion notification be transmitted as a collective completion notification.

<Summary>

So far, the present invention has been described based on the embodiments and the modification examples. However needless to say, the present invention should not be limited to concrete examples stated as the embodiments and the modification examples. For example, other modification examples are also possible.

1. Client Terminal

In the above-described embodiments and the modification examples, e-mail to be transmitted from the MFP is received by a fixed client terminal by accessing the mail server (either automatically or manually). However, it is also possible to realize the present invention in a webmail system where any client terminal can access the mail server and so does not require a fixed client terminal.

2. Completion Notification

In the above-described embodiments and the modification examples, e-mail is used as a (completion) notification. However other means may be used to report job completion to a user of a client terminal. Such means include a case of transmitting a message (packet) that uses TCP/IP on a LAN network from an image forming apparatus (e.g. MFP).

Furthermore, it is also possible to send e-mail directly to a portable telephone or a portable terminal of the user of the client terminal.

3. Cancellation of Halt State

In the third modification example that relates to the third embodiment, when the current time has become one of the predetermined times, it is judged that the halt state should be cancelled. However, a structure is also possible in which completion notification halting is only directed to print jobs corresponding to all the predetermined print instructions, and that the halt state is cancelled when a predetermined time has passed after completion of the print jobs relating to the halting. Still further, the halt state may also be cancelled when the number of print jobs relating to the halting has reached a predetermined number.

4. Image Forming Apparatus

An example of the image forming apparatus, described in the embodiments and the like, is an MFP into which its main control unit is integrated. However, it is also possible to adopt, as the image forming apparatus, an MFP of a management unit type (separate type) in which the main control unit is separate from the engine unit or the like. In other words, the present invention is able to be implemented in such a management-unit type MFP and still has the same advantage just as in the embodiments and the modification examples, if its management unit includes the function of the main control unit of the embodiments and the like. It should be noted that in the present specification, the MFP has been described without distinguishing between the integrated type and the separate type.

5. Other Notes

Each of the embodiments and the like descried so far is directed to an image forming apparatus. However, a program operable to make an image forming apparatus execute such operations as described in the embodiments can be stored in a readable recording medium to be distributed for dealings.

In addition, the program may be distributed via a network and the like for dealings. The program may also be installed in an image forming apparatus via the network. Furthermore, the program may be presented to a user by being displayed on a display apparatus, or by being printed in printed form.

Here, examples of the readable recording medium are: a removable recording medium such as a floppy disk, a CD, an MO, a DVD, and a memory card; and a fixed recording medium such as a hard disk and a semiconductor memory. However, the readable recording medium is not particularly limited to the mentioned concrete examples.

Although the present invention has been fully described by way of examples with references to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image forming apparatus that executes a print job according to a print instruction from a client terminal, and transmits a completion notification of the print job to the client terminal, the image forming apparatus comprising:
a halting unit for, when the print job satisfies a predetermined condition, creating a halt state in which transmission of the completion notification is halted; and
a collective notification unit for, if the halt state is cancelled with a plurality of completion notifications being halted, transmitting the plurality of completion notifications as at least one collective notification, a number of the at least one collective notification being smaller than a number of the plurality of completion notifications.

2. The image forming apparatus of claim 1, further comprising:
a halting judgment unit for judging whether the print job satisfies a predetermined condition, wherein
the halting judgment unit judges in the affirmative if another print instruction is received from the client terminal subsequent to the print instruction regarding the print job.

3. The image forming apparatus of claim 2, wherein
the halting judgment unit performs the judgment by checking whether the print instruction regarding the print job is assigned sequential information indicating a presence of another print instruction to be received from the client terminal subsequent to the print instruction regarding the print job.

4. The image forming apparatus of claim 2, further comprising:
a cancellation judgment unit for judging whether the halt state should be cancelled, wherein
the cancellation judgment unit judges in the affirmative if no print instruction is received subsequent to the print instruction regarding the print job.

5. The image forming apparatus of claim 4, wherein
the cancellation judgment unit performs the judgment by checking whether the print instruction regarding the print job is assigned last-job information indicating no presence of another print instruction to be received from the client terminal subsequent to the print instruction regarding the print job.

6. The image forming apparatus of claim 5, wherein
the collective notification unit, when a print instruction assigned the last-job information has not been received for a predetermined time from a most recent print job completion, transmits the collective notification.

7. The image forming apparatus of claim 2, further comprising:
an accumulation unit for accumulating information relating to a print job whose print instruction has been received, wherein
the halting judgment unit judges in the affirmative when a new print instruction is received from the client terminal before transmission of a completion notification of an already completed print job issued from the client terminal.

8. The image forming apparatus of claim 7, further comprising:
a cancellation judgment unit for judging whether the halt state should be cancelled, wherein
the halting judgment unit judges in the affirmative when the accumulation unit stores information relating to notification regarding any print job already completed, and
the cancellation judgment unit judges in the affirmative when all print jobs whose information is stored in the accumulation unit are completed.

9. The image forming apparatus of claim 1, further comprising:
a halting judgment unit for judging whether the print job satisfies a predetermined condition, wherein
the halting judgment unit judges in the affirmative when information regarding a destination of the completion notification is the same as information regarding a predetermined destination.

10. The image forming apparatus of claim 1, further comprising:
a halting judgment unit for judging whether the print job satisfies a predetermined condition, wherein
the halting judgment unit judges in the affirmative when a print result of the print job is the same as a predetermined print result.

11. The image forming apparatus of claim 1, further comprising:
a halting judgment unit for judging whether the print job satisfies a predetermined condition; and
a cancellation judgment unit for judging whether the halt state should be cancelled, wherein
the halting judgment unit judges in the affirmative when the print job completes within a predetermined time, and
the cancellation judgment unit judges in the affirmative when the predetermined time has elapsed.

12. The image forming apparatus of claim 1, further comprising:
a cancellation judgment unit for judging whether the halt state should be cancelled, wherein
the cancellation judgment unit judges in the affirmative when a number of print jobs whose completion notification has not been transmitted due to the halt state has reached a predetermined number.

13. The image forming apparatus of claim 7, further comprising:
a cancellation judgment unit for judging whether the halt state should be cancelled, wherein
the cancellation judgment unit judges in the affirmative when a number of print jobs whose completion notification has not been transmitted due to the halt state has reached a predetermined number.

14. The image forming apparatus of claim 1, further comprising:
a cancellation judgment unit for judging whether the halt state should be cancelled, wherein
the cancellation judgment unit judges in the affirmative when a predetermined time has elapsed after completion of the print jobs whose completion notification has not been transmitted due to the halt state.

15. The image forming apparatus of claim 7, further comprising:
a cancellation judgment unit for judging whether the halt state should be cancelled, wherein
the cancellation judgment unit judges in the affirmative when a predetermined time has elapsed after completion of the print jobs whose completion notification has not been transmitted due to the halt state.

16. The image forming apparatus of claim 9, further comprising:
a cancellation judgment unit for judging whether the halt state should be cancelled, wherein
the information regarding the destination of the completion notification is information about a group to which the destination belongs, and
the halting judgment unit judges in the affirmative when the information regarding the destination of the completion notification is the same as information about a predetermined group,
the cancellation judgment unit judges in the affirmative when a print job whose information regarding a destination of a completion notification is the same as the information about a predetermined group has been completed, and
the collective notification unit transmits the collective notification to members constituting the predetermined group.

17. The image forming apparatus of claim 1, wherein
when the print job has not been successfully completed, the collective notification unit adds a notification about the unsuccessful completion of the print job, to the collective notification before transmission.

18. The image forming apparatus of claim 16, wherein
when the print job has not been successfully completed, the collective notification unit adds a notification about the unsuccessful completion of the print job, to the collective notification before transmission.

19. A recording medium storing therein a program for making an image forming apparatus execute processing, the image forming apparatus executing a print job according to a print instruction from a client terminal, and transmitting a completion notification of the print job to the client terminal, the processing comprising:
halting processing of, when the print job satisfies a predetermined condition, creating a halt state in which transmission of the completion notification is halted; and
collective notification processing of, if the halt state is cancelled with a plurality of completion notifications being halted, transmitting the plurality of completion notifications as at least one collective notification, a number of the at least one collective notification being smaller than a number of the plurality of completion notifications.

20. A print-job completion notification method of transmitting a completion notification of a print job to a client terminal after the print job has been executed according to a print instruction from the client terminal, the method comprising:
a halting step of, when the print job satisfies a predetermined condition, creating a halt state in which transmission of the completion notification is halted; and
a collective notification step of, if the halt state is cancelled with a plurality of completion notifications being halted, transmitting the plurality of completion notifications as at least one collective notification, a number of the at least one collective notification being smaller than a number of the plurality of completion notifications.

21. The print-job completion notification method of claim 20, further comprising:
a halting judgment step of judging whether the print job satisfies a predetermined condition, wherein
the halting judgment step results in the affirmative if another print instruction is received from the client terminal subsequent to the print instruction regarding the print job.

22. The print-job completion notification method of claim 20, further comprising:
a halting judgment step of judging whether the print job satisfies a predetermined condition, wherein
the halting judgment step results in the affirmative when information regarding a destination of the completion notification is the same as information regarding a predetermined destination.
